(19) United States
(12) Patent Application Publication
(10) Pub. No.: US 2025/0117687 A1
(43) Pub. Date: Apr. 10, 2025

(54) Automatic Content Generator for Construction-Based Data Objects

(71) Applicant: Procore Technologies, Inc., Carpinteria, CA (US)

(72) Inventors: Matt Man, Thornhill (CA); Mohammad Mostafa Soltani, Toronto (CA); Catherine Knuff, Brooklyn, NY (US); Farid Mirahadi, North York (CA); Gagik Hacobian, La Crescenta, CA (US); Carolyn Langford, Austin, TX (US)

(21) Appl. No.: 18/481,060

(22) Filed: Oct. 4, 2023

(51) Int. Cl. G06N 20/00

(52) U.S. Cl. CPC G06N 20/00

(57) ABSTRACT

A computing platform is configured to: (i) train a machine-learning model by carrying out a machine learning process on a training data set that includes historical construction-based data objects, (ii) receive a request to generate a construction-based data object associated with an ongoing construction project, (iii) receive data values for data fields of the construction-based data object, (iv) input one or more data values for data fields of the construction-based data object into the machine-learning model, as the input data values, and thereby generate an updated data value for the data fields, (v) cause a client device to present a visual interface, the visual interface usable for viewing an indication of the construction-based data object and an indication of the updated data value, and (vi) update the data fields of the construction-based data object, based on the updated data value.

### BACKGROUND

Construction projects are often complex endeavors involving the coordination of many professionals across several discrete phases. Such projects have multiple planning and building phases that occur and require lengthy communication. The planning phases may involve contract bidding, contractor selection, project feasibility studies, regulatory approval and/or permitting, among other known planning phases.

Typically, a construction project commences with a design phase, where architects design the overall shape and layout of a construction project, such as a building. Next, engineers engage in a planning phase where they take the architects' designs and produce engineering drawings and plans for the construction of the project. At this time, engineers may also design various portions of the project's infrastructure, such as HVAC, plumbing, electrical, etc., and produce plans reflecting these designs as well.

After, or perhaps in conjunction with, the planning phase, contractors may engage in a logistics phase to review these plans and begin to allocate various resources to the project, including determining what materials to purchase, scheduling delivery, and developing a plan for carrying out the actual construction of the project. Finally, during the construction or implementation phase, construction professionals begin to construct the project based on the finalized plans.

Such construction planning, design, and implementation may involve massive amounts of events and information that requires documentation and accurate reporting. Software technology has been developed to enable electronic management of information associated with a construction project, which includes documenting events and information associated with a construction project.

### Overview

As mentioned above, software technology has been developed to enable computing platforms to ingest and store information associated with construction projects, to facilitate electronic management of construction projects and associated information and data. However, the construction industry remains susceptible to various inefficiencies related to information management and knowledge transfer. Particularly, many issues arise regarding proper organization and quality control of construction-based information, when projects are spread out amongst many different parties and each party may have varied experience levels and standards for quality control.

As defined herein, a “construction project” refers to any building, construction, demolition, and/or removal of a structure, tenant and/or owner improvement of an existing space, public or private infrastructure, landscaping, greenery, or otherwise large-scale movement or construction of property on real estate. A “construction project task” refers to one or more sub-divided tasks associated with the defined construction project, which may be one of a planning task, an engineering task, and/or a construction task, among other possibilities. While data is collected from a variety of different operations and/or tasks associated with a construction project, as discussed in more detail below, there is a need to organize the collected data and outcomes of any processing of said data, on a regular, timely basis.

The construction industry, generally, may be adversely affected by knowledge transfer issues. As experienced workers reach retirement age, they leave the industry and take their knowledge and expertise with them. This may result in generations of construction workers and/or managers that are not adequately trained. Additionally or alternatively, this knowledge transfer issue may arise from a lack of newly trained, younger workers entering the industry; thus, even if a jobsite is able to find available, younger workers, said workers may not possess adequate training, for the tasks with which they are assigned. Further still, even if these newer workers know the “how” of performing a construction task, they may not have enough of a well-trained eye to identify what is a proper or acceptable task-completion. Accordingly, quality control issues and/or inconsistencies may arise from the lack of an adequately trained workforce.

If there is a lack of adequate training and/or quality control for workers, said workers may not have the adequate skills to report or notate data in construction-based data objects associated with a given construction project or task thereof. Accordingly, the quality and/or completeness of construction-based data objects may be adversely affected due to the inadequate knowledge transfer and quality control consistency, within the construction industry.

To that end, computer-based services for aiding in planning and executing aspects of a construction project, such as those developed and maintained by Procore Technologies, may be of assistance in alleviating some of the knowledge gaps created by the lack of adequate training and/or knowledge transfer. One or more applications of a construction management software service may be useful in both ingesting and compiling data for use in the preparation of construction-based data operations and/or objects. Such applications include, but are not limited to including, scheduling applications, timesheet applications, request for information (RFI) applications, change order applications, conversations or messaging applications, construction project punch list applications, financial applications (e.g., budget applications, invoicing applications, payment processors, etc.), architectural and/or structural design applications, among other known applications within a construction management software service, such as those developed and maintained by Procore Technologies.

“Data objects,” as defined herein, generally refer to an electronic representation of a type of data record related to a project or task. In some examples, the computing platform associated with such data objects operates to facilitate the electronic management of construction project information. In such examples, the data objects are, generally, associated with one or more construction projects or tasks. Examples of construction-based data objects include, but are not limited to including requests for information (RFIs), submittals, conversations, schematics, invoices, punch lists, observations, drawing objects, workflows, contracts, change orders, among other construction-based data objects known in the art.

As one example, an RFI data object, generally, refers to a data object representative of a process initiated by a user of the platform (e.g., a general contractor, a subcontractor, a supplier, etc.) to request information or raise concerns that must be formally answered by another user of the platform (e.g., a contractor's client, a project's architect, a project's engineer, etc.). In some examples, the answering user's answer to the RFI may change a project's scope (e.g., leading to a change order data object) and/or require approval from another user of the platform.

While construction-based data objects may, generally, be helpful to account for issues of inadequate training and/or knowledge transfer, proper generation and/or data population for construction-based data objects may be adversely affected by the aforementioned inadequacy in knowledge transfer, among groups of construction workers. For example, if an RFI is created by a worker who does not know the correct party to request information from, project delays could occur because the RFI was not sent to the correct party and, thus, the delay in information sharing leads to confusion. As another possibility, a party generating an RFI may not specifically know who to send the RFI to, so he/she/they may send the RFI to many people or parties. In this scenario, no one may reply, as each party believes another party subject to receipt of the RFI is handling the answer to the RFI. Lacking specificity in assignment, as discussed, may delay response to the RFI which, thus, may delay the construction project, as a whole.

Additionally or alternatively, inexperienced workers may have a tendency to create unnecessary RFIs, thus introducing inefficiencies into the construction project, because the inexperienced worker does not realize that the information he/she/they are requesting is available by viewing previously documented information that is available to them. However, this inadequacy may not be fully the fault of the inexperienced worker, as the data (e.g., contracts, plans, specifications, etc.) associated with a construction project becomes larger and more complex over time, such that odds are increased that an inexperienced worker will not be able to find the information needed, within the more complex documentation. Because the worker does not have the searching capabilities and/or knowhow to find the information needed, he/she/they may generate unnecessary RFIs for information that was readily available to him/her/them.

Further still, inexperience may result in workers not understanding proper context, when utilizing construction-based data objects in their day-to-day tasks. A relatively inexperienced project manager may submit or receive an RFI requesting information; however, the RFI may be unnecessary, as the information requested is readily available within the data that is accessible to the submitting or receiving party. Although technically this information is “available” to the receiving party of the RFI, this information needed may be buried within complex and lengthy specification documents and the associated communications. Thus, the receiving or submitting party of the RFI may be unaware of this existence or may be so inexperienced that he/she/they do not know to check these documents, when either generating or responding to said RFI.

Consider an example, wherein a project specification data object may detail all the paint colors for rooms in a building of a construction project; however, the project specification may be silent to the desired paint colors for the closets within said rooms. An inexperienced recipient of the RFI, requesting information regarding the closet paint colors, may respond with a change to the specification for the construction project, such as a change order. Whereas, if a more experienced recipient were to respond to the RFI, they might indicate that the requested information already exists elsewhere in the project documentation, such as on a drawing or in a contract indicating that the paint colors for closets are to match their associated rooms. In this scenario, not only is a change order unnecessary, but the RFI is unnecessary in the first instance.

Other drawbacks are also possible when utilizing a computing platform for gathering and compiling construction project information, even when the user (e.g., a worker or a manager) is an experienced practitioner in his/her/their construction field. For instance, some data objects may still have deficiencies due to overlooked information, because even a well-organized construction management platform may overwhelm an experienced user with too much data. Further, while an experienced practitioner is in a better position to adequately complete data objects, such as RFIs, these practitioners, after all, are still human beings and, thus, may still experience periodic forgetfulness, leading to potential omission of data when completing entries to a data object. Additionally, even for a skilled practitioner, finding the information needed is often very time consuming, particularly when the information gathered must be predictable, accurate, data. Lastly, even the most experienced practitioner may lack the insight and context that may be gained from review and ingestion of historic data from thousands, if not millions, of past construction projects.

In view of all of the above, the new technologies disclosed herein aim to utilize a computing platform and data collected thereon to improve, simplify, automate, prioritize, and/or optimize the generation of construction-based data objects. The computing platform, such as a computing platform installed with one or more construction management software services, may utilize the data collected from applications and/or application program interfaces (APIs) thereof to assist in generating content for construction-based data objects. An “API,” as defined herein, refers to an interface for one or more computer programs to communicate with one another, which offers some service or functionality to the other program(s).

For implementing automatic construction-based data object content generation, within a computing platform, various systems, software, and/or databases utilizing machine learning and/or artificial intelligence (AI) can be leveraged for intelligent ingestion and processing of construction project information. For example, machine-learning models can be utilized to ingest new data that is generated throughout the planning, design, and implementation phases of a construction project and associate that data with events that may be useful in generating construction activity summaries. Such data can be in the form of, but not limited to the form of, text, drawings, photos, audio, transcripts, videos, 3-dimensional (3-D) models, and sensor data. Such ingestion and/or training of a machine-learning model, based on input construction-based data objects, may take the form of one or more supervised training models, unsupervised training models, or combinations thereof.

As a precursor to generating construction-based data objects, a computer vision model can be used to interpret what is captured within photos and convert it into text as input to the machine-learning model. Similarly, an anomaly detection model can be used on a stream of IoT sensor data and generate a textual input to the machine-learning model for content generation for construction-based data objects.

Thus, as machine-learning models are useful in both predicting text and automatically generating content based on a contextual input, the systems and methods disclosed herein may utilize machine-learning models, in automatically generating content for construction-based data objects, by leveraging data input to a computing platform associated with one or more construction management software services. The data input to the computing platform that is leveraged by the machine-learning model may include both historic construction project data (e.g., historic construction project data associated with the current user and/or other users of the platform) and construction project data associated with a current, ongoing construction project, for which the content for construction-based data objects is generated.

By utilizing historic construction project data that has been previously input to the computing platform, the machine-learning model may be trained with the contextual language and contextual data that is specific to the construction management software service and the various construction-based industries that use it. For example, the machine-learning model will “learn” the language of the various construction applications provided by the platform, including the general language of the construction industries themselves (e.g., specific construction trades such as plumbing, electrical, concrete, etc.). In this way, the machine-learning model may be enabled to predict and/or generate text that is comparable to text that would be provided by a skilled worker who, historically, compiled the data for a construction-based data object.

Further still, while generating said content for construction-based data objects, the machine-learning model may be retrained upon each new input to the computing platform. Additionally, the machine-learning model may re-ingest the output data of processes executed by the computing platform, which may or may not include user modification, and learn various restraints/parameters (e.g., rankings of importance, ordering of data, etc.). For instance, the computing platform and/or an application for generating said construction-based data objects may provide a means for the user to provide input associated with the construction-based data objects, such as, but not limited to, an approval that the construction-based data object input is accurate, a disapproval of input, text edits and/or ordering edits to the construction-based data object, among other forms of user input associated with the generated content for a construction-based data object. The machine-learning model may then ingest the edits, learn from the edits, and be able to better predict what the user wants from his/her/their content, by learning from, for example, how the user ranks the importance of aspects of the construction-based data objects.

Of particular use in generating content for construction-based data objects, the specific machine-learning models and/or techniques may relate to forms of natural language processing (“NLP”). NLP, generally, refers to an interdisciplinary field of linguistics and computer science that is concerned with processing natural language datasets, such as text corpa or speech corpa, using either rule-based or probabilistic machine learning methods. The aim of NLP is to generate models that are capable of understanding the context and meaning of data that is ingested by the model, such that the NLP model can “learn” the language or contextual meaning of terms and/or language. Thus, when utilizing machine-learning models that employ NLP in generating construction activity summaries, by training the model based on historic construction project data held in the computing platform, it will “learn” the contextual nuances of the construction projects and/or the industries thereof.

While, generally, NLP is useful for automatic generation of content for construction-based data objects, new technologies in the field of large language models (LLMs) have the potential to generate even more accurate and optimized construction activity summaries. A LLM refers to a complex machine-learning model that utilizes AI accelerator hardware to process vast amounts of text data, which may be scraped from a variety of sources, such as, but not limited to, the Internet. LLMs utilize artificial neural networks comprising millions or even billions of weights, which are then used for one or more of self-supervised learning, semi-supervised learning, or combinations thereof. LLMs operate by taking an input text and repeatedly predicting the next word input by the input text; the LLM can then review the input text versus the predictions to rank its accuracy and “learn” how to “speak” in the context of the scenario of the input text. Examples of LLMs include, but are not limited to including, Generative Pre-trained Transformer (GPT) models (e.g., GPT-3, GPT-3.5, GPT-4, ChatGPT), pathways language models (PaLM), Large Language Model Meta AI (LLaMA), BigScience Large Open-science Open-access Multilingual Language Model (BLOOM), Bidirectional Encoder Representations from Transformers (BERT), among other known models and/or techniques.

One particular example of a useful architecture for machine learning and/or LLM generation is the transformer model or architecture. Transformer models utilize an attention mechanism to determine key points of context within language datasets. For example, transformer models may split a language data stream into encoded tokens, which are converted to vectors via lookup in a word embedding table of the transformer model; then, each token is contextualized within the model to determine key tokens to be amplified and lesser tokens to be diminished. In other words, transformer models “transform” text into data points, which then can be compared with similar text data to determine the importance of each section of the data, for use in future predictions or generation of text.

Training and/or retraining of an LLM, as disclosed herein, may include fine-tuning an LLM based on the specific data sets associated with, for example, a construction management platform. To that end, “fine tuning.” generally refers to a process of re-training a more generic, pre-trained LLM, based on a specific dataset; said fine-tuning may allow the LLM to adapt to the specific context of an industry and/or platform. For example, training and/or re-training of the LLMs, disclosed herein, may include fine tuning the LLM based on specific, construction-based data sets. By employing such fine-tuning of an LLM, the LLM may be configured to “speak” the language of a specific industry and/or computing platform, such as the construction industry and/or a computing platform associated therewith.

Additionally, as the LLM will have been trained to understand the form and contextual meaning of various forms of data on the construction management platform, it may have capabilities for determining discrepancies in data or actions performed in the construction project, based on its learnings from the ingestion of historical construction data.

In some examples of the disclosed technology, the aforementioned training processes may be based on ingestion of construction-based data objects, wherein each of the ingested data objects includes, or is otherwise associated with, a resolution and/or outcome associated with data held in the ingested data objects. A “resolution” of a data object, as defined herein, is an indication of an action or outcome that occurred during entry and/or completion of data entry for a given data object. In other words, a “resolution” to a construction-based data object may be indicative of outcome associated with a data object, such as an approval, a disapproval, a resolution of discrepancies, a confirmation, an acceptance, a completion, a modification, and the like. For example, a resolution to an RFI may be a response to a question and subsequent acceptance and/or approval of the answer to the RFI, by the initial submitter. Alternatively, a resolution may be an indication by a manager/initiator that the answer in the RFI is unclear or otherwise inadequate; this resolution may further include data associated with how the RFI answer was subsequently revised to overcome the inadequacies. Further still, in other construction-based data objects, which require acceptance or rejection, the resolution may include the acceptance or rejection and reasons why the data object was accepted or rejected and/or the parties that did the accepting or rejecting. Such data objects, wherein a resolution may include an acceptance or rejection, include, but are not limited to including, submittals, such as change orders, inspection reports, time sheet entries, invoices and other financial documents, among various other things.

Thus, historic construction-based data objects, data fields of said data objects, data entries to the data fields of the data objects, and associated resolutions can be input to a machine-learning model to train the model to understand the construction industry and its associated data object forms and inputs. By subsequently re-training the machine-learning model based on generated data objects and/or content thereof, either collected for a specific party or for an entire computing platform and its clients, the machine-learning model may become “smarter.” In other words, the machine-learning model may become more accurate in predicting outcomes of construction-based data objects, assessing quality of one or more entries to a construction-based data object, and/or may be capable of creating and populating construction-based data objects in whole or in part, based on minimal user input or contextual actions.

In some examples of the technology disclosed herein, the discussed machine-learning models may be utilized in assisting a user in the preparation of a construction-based data object. In such an example, the user creates a construction-based data object and completes entry of data values into one or more data fields of the construction-based data object. A “data field” of a data object, as defined herein, refers to any field in a data object wherein a data entry may reside, whether the entries to the data field are editable or not by a user or a computing platform. The machine-learning model may be configured for assessing quality of an entry to a data field, assessing outcomes based on an entry to a data field, automatically generating an entry to a data field, automatically populating or suggesting an entry to a data field, among other ways of altering, generating, or assessing data entries to the data fields.

For data objects that include, at least, a field for a recipient or respondent to the data object, the systems and methods disclosed herein may be useful in one or more of choosing a recipient, assessing the likelihood that the entered recipient will respond to receipt of the data object, automatically generating a most likely appropriate recipient for the data object, among other things. In one example, the party that generates the construction-based data object may initially enter a plurality of recipients to the construction-based data object; however, as discussed above, entering many recipients may lessen the likelihood of response to the data object. Then, via use of the machine-learning model(s), the technology disclosed herein may be utilized to determine who of the list of recipients is one or more of the likeliest to respond to the data object, the most qualified to respond to the data object, or combinations thereof. Then, the systems and methods carried out by the computing platform may populate the recipient data field of the object based on output of the machine-learning model. In another example, a recipient is input to the recipient field and, based on inputting the recipient to the machine-learning model, the systems and methods disclosed herein may assess the likelihood that the input recipient will respond to the machine-learning model. Such recipient-based generative content technologies may be particularly useful for generating content for construction-based data objects that require a response from another party, such as, but not limited to, RFIs and submittals.

Construction projects and/or tasks thereof, generally, must be completed within a finite time frame, wherein timing is imperative to avoid delays and associated extra costs. To that end, many construction-based data objects include a deadline field, indicative of a deadline for completing at least one task of a current construction project. In such examples, the machine-learning assisted systems and methods may be utilized for (i) determining if an input to a timeline field is achievable, accurate, and/or possible to meet, (ii) generating an appropriate deadline for completion of the task and/or entry to the construction-based data object, and/or (iii) suggesting a new deadline for the deadline field based on knowledge of events associated with the current construction project and/or historic construction projects similar to the current construction project.

As discussed above, various machine-learning models, such as those that leverage NLP for generating real, human-like language, can be utilized in generating or altering text for a construction-based data object. To that end, for content generation purposes, the machine-learning models discussed herein may generate, alter, edit, or otherwise enter text into text fields of construction-based data objects, based on a quality assessment of previous entries to text fields.

For example, consider a program on a computing platform for generating RFIs. A manager of an RFI enters text into a text field of a data object for an RFI and, subsequently, the text field entry is input to the machine-learning model, wherein quality of the text entry is assessed by the machine-learning model. The machine-learning model may then provide, as output, suggestions for editing the text, so that a respondent to the RFI will be more likely to quickly and/or adequately respond to the question of the RFI.

In another example including text fields associated with RFI data objects, the machine-learning models may be utilized by the systems and methods disclosed herein to assess quality of a text field entry for an answer to a question of an RFI and use said assessment for altering the data entry to the text field. For example, the machine-learning model may receive, as input, a text entry to an answer text field of an RFI data object, determine a quality assessment of the text in the answer text field and, based on the quality assessment, determine if the answer will likely be approved by the manager of the RFI. In such examples, if the assessment by the machine-learning model determines that the manager of the RFI most likely will not approve of the answer, the machine-learning model may generate an altered or alternative text entry for the text entry for the answer field that is possibly more accurate or more responsive to the RFI, among other possibilities. Based on the machine-learning model's assessment of quality, the altered or alternative text entry may be more likely to be approved by the RFI manager.

Further still, with enough training and knowledge of a current construction project, in some examples, the systems and methods disclosed herein may utilize the disclosed machine-learning models to automatically generate data for an answer field for a submittal-based construction-based data object. For example, a user may generate an RFI data object and input text data into a question-based text field for the RFI data object. The machine-learning model may ingest the input text data, as input, and determine that the machine-learning model is capable of answering the question of the question-based text field, absent input by a recipient or respondent. In such an example, the machine-learning model may provide output used by the computing platform to inform the user that the computing platform has enough information to answer the question and/or ask the user if he/she/they would like the computing platform to automatically generate an answer to the input of the question-based text field. Then, the machine-learning model may provide output to provide a text-based answer as a new data entry to an answer-based text field.

While some of the aforementioned examples of utilizing the disclosed technology for automatically generating content for construction-based data objects may require at least some nominal data input to fields of a data object, prior to content generation for the data object, in some other examples, the machine-learning models disclosed herein may be utilized to automatically generate construction-based data objects based on one or more of contextual input to the computing platform, general observations of actions of a user made by the machine-learning model, input to the machine-learning model, or combinations thereof. For example, a user of the computing platform, via a client station, may input a broad search query (e.g., what color are the closets to be painted), either via a search function for data on the platform or another application for finding information. The computing system and/or the associated machine-learning models may attempt to provide the user with a correct answer to this query.

However, if that information is not confidently held in or supported by data of the computing platform and/or machine-learning model, then the machine-learning model may automatically generate a construction-based data object, for the purposes of answering the user's search query. For example, the machine-learning model may provide output that is leveraged by the computing system to automatically generate an RFI requesting an answer for the query. Additionally or alternatively, the machine-learning model and/or an input process thereof may monitor activity of a user on the platform and, based on the context of the user's actions (e.g., what file folders the user is opening, what documents the user is viewing currently, etc.) predict that the user is searching for some specific set of information. In said examples, rather than reacting to a search query, the machine-learning model may generate a suggestion to generate a construction-based data object, based on observations of the user's actions, and, in response to affirmative input to the suggestion to generate the construction-based data object, provide output to the computing system for generating the predicted construction-based data object.

In line with the discussion above, the disclosed technology may be implemented as one or more software applications that facilitate the creation and management of data during the course of a construction project, some examples of which may include the types of software applications developed by Procore Technologies. Further, in practice, the computing platform in which the disclosed technology is incorporated may take the form of a software as a service (“SaaS”) application that comprises a front-end software component running on a user's client station or end-user device and a back-end software component running on a back-end computing platform that is accessible to the user client station or end-user device via a communication network such as the Internet.

In one aspect, disclosed herein is a method that involves a computing platform (i) training a machine-learning model by carrying out a first machine learning process on a training data set that includes a plurality of historical construction-based data objects, each of the plurality of historical construction-based data objects including (a) one or more data fields comprising respective historical data values and (b) a respective indication of a resolution of the historical construction-based data object, wherein the machine-learning model is configured to (a) receive, as input, one or more input data values for one or more data fields of a construction-based data object, the construction-based data object associated with a construction project, (b) output an output updated data value for at least one of the one or more data fields of the construction-based data object, (ii) receiving a request to generate a current construction-based data object associated with an ongoing construction project, (iii) receiving one or more data values for one or more current data fields of the current construction-based data object, (iv) inputting one or more data values for the one or more current data fields of the current construction-based data object into the machine-learning model, as the input data value, and thereby generating a current updated data value for at least one of the one or more current data fields, (v) causing a client device to present a visual interface, the visual interface usable for viewing an indication of the current construction-based data object and an indication of the current updated data value, and (vi) updating the one or more current data fields of the current construction-based data object, based on the current updated data value.

In another aspect, disclosed herein is a computing platform that includes a network interface, at least one processor, a non-transitory computer-readable medium, and program instructions stored on the non-transitory computer-readable medium that are executable by the at least one processor to cause the computing platform to carry out the functions disclosed herein, including but not limited to the functions of the foregoing method.

In yet another aspect, disclosed herein is a non-transitory computer-readable storage medium provisioned with software that is executable to cause a computing platform to carry out the functions disclosed herein, including but not limited to the functions of the foregoing method.

One of ordinary skill in the art will appreciate these as well as numerous other aspects in reading the following disclosure.

### BRIEF DESCRIPTION OF THE DRAWINGS

FIG. 1 depicts an example network configuration in which example embodiments may be implemented.

FIG. 2 depicts an example computing platform that may be configured to carry out one or more of the functions according to the disclosed technology.

FIG. 3 depicts a structural diagram of an example end-user device that may be configured to communicate with the example computing platform of FIG. 2 and also carry out one or more functions in accordance with the disclosed technology.

FIG. 4 depicts a flow diagram of an example process for automatically generating content for a construction-based data object, according to one possible implementation of the disclosed technology.

FIG. 5A is an example depiction of a construction-based data object, according to one possible implementation of the disclosed technology.

FIG. 5B is another example depiction of the construction-based data object of FIG. 5A, including a current data entry to one of the data fields, according to one possible implementation of the disclosed technology.

FIG. 5C is another is an example depiction of the construction-based data object of FIGS. 5A-5B, including an updated data entry to one of the data fields, according to one possible implementation of the disclosed technology.

FIG. 6 depicts a schematic diagram illustrating example aspects of an example machine-learning model, utilized in conjunction with the systems and methods herein, according to one possible implementation of the disclosed technology.

FIG. 7 depicts an example graphic interface utilized in generating and/or viewing a construction-based data object, according to one possible implementation of the disclosed technology.

FIG. 8 depicts a flow diagram of an example process for automatically generating content associated with a recipient field of a construction-based data object, according to one possible implementation of the disclosed technology.

FIG. 9A depicts a first state of an example graphic interface for viewing and/or generating a construction-based data object, in accordance with the process of FIG. 8 and one possible implementation of the disclosed technology.

FIG. 9B depicts a second state of an example graphic interface for viewing and/or

generating a construction-based data object, in accordance with the process of FIG. 8 and one possible implementation of the disclosed technology.

FIG. 9C depicts a third state of an example graphic interface for viewing and/or generating a construction-based data object, in accordance with the process of FIG. 8 and one possible implementation of the disclosed technology.

FIG. 10 depicts a flow diagram of another example process for automatically generating or altering content associated with a recipient field of a construction-based data object, according to one possible implementation of the disclosed technology.

FIG. 11A depicts a first state of an example graphic interface for viewing and/or generating a construction-based data object, in accordance with the process of FIG. 10 and one possible implementation of the disclosed technology.

FIG. 11B depicts a second state of an example graphic interface for viewing and/or generating a construction-based data object, in accordance with the process of FIG. 10 and one possible implementation of the disclosed technology.

FIG. 11C depicts a third state of an example graphic interface for viewing and/or generating a construction-based data object, in accordance with the process of FIG. 10 and one possible implementation of the disclosed technology.

FIG. 12 depicts a flow diagram of an example process for automatically generating or altering content associated with a deadline field of a construction-based data object, according to one possible implementation of the disclosed technology.

FIG. 13A depicts a first state of an example graphic interface for viewing and/or generating a construction-based data object, in accordance with the process of FIG. 12 and one possible implementation of the disclosed technology.

FIG. 13B depicts a second state of an example graphic interface for viewing and/or generating a construction-based data object, in accordance with the process of FIG. 12 and one possible implementation of the disclosed technology.

FIG. 13C depicts a third state of an example graphic interface for viewing and/or generating a construction-based data object, in accordance with the process of FIG. 12 and one possible implementation of the disclosed technology.

FIG. 14 depicts a flow diagram of an example process for automatically generating or altering content associated with a text field of a construction-based data object, according to one possible implementation of the disclosed technology.

FIG. 15A depicts a first state of an example graphic interface for viewing and/or generating a construction-based data object, in accordance with the process of FIG. 14 and one possible implementation of the disclosed technology.

FIG. 15B depicts a second state of an example graphic interface for viewing and/or generating a construction-based data object, in accordance with the process of FIG. 14 and one possible implementation of the disclosed technology.

FIG. 15C depicts a third state of an example graphic interface for viewing and/or generating a construction-based data object, in accordance with the process of FIG. 14 and one possible implementation of the disclosed technology.

FIG. 16 depicts a flow diagram of an example process for automatically generating or altering content associated with an approval for a construction-based data object, according to one possible implementation of the disclosed technology.

FIG. 17A depicts a first state of an example graphic interface for viewing and/or generating a construction-based data object, in accordance with the process of FIG. 16 and one possible implementation of the disclosed technology.

FIG. 17B depicts a second state of an example graphic interface for viewing and/or generating a construction-based data object, in accordance with the process of FIG. 16 and one possible implementation of the disclosed technology.

FIG. 17C depicts a third state of an example graphic interface for viewing and/or generating a construction-based data object, in accordance with the process of FIG. 16 and one possible implementation of the disclosed technology.

FIG. 18 depicts a flow diagram of an example process for automatically generating content associated with an answer for a construction-based data object, according to one possible implementation of the disclosed technology.

FIG. 19A depicts a first state of an example graphic interface for viewing and/or generating a construction-based data object, in accordance with the process of FIG. 18 and one possible implementation of the disclosed technology.

FIG. 19B depicts a second state of an example graphic interface for viewing and/or generating a construction-based data object, in accordance with the process of FIG. 18 and one possible implementation of the disclosed technology.

FIG. 19C depicts a third state of an example graphic interface for viewing and/or generating a construction-based data object, in accordance with the process of FIG. 18 and one possible implementation of the disclosed technology.

FIG. 20 depicts a flow diagram of an example process for automatically generating a construction-based data object, according to one possible implementation of the disclosed technology.

FIG. 21A depicts a first state of an example graphic interface for viewing and/or generating a construction-based data object, in accordance with the process of FIG. 20 and one possible implementation of the disclosed technology.

FIG. 21B depicts a second state of an example graphic interface for viewing and/or generating a construction-based data object, in accordance with the process of FIG. 20 and one possible implementation of the disclosed technology.

FIG. 21C depicts a third state of an example graphic interface for viewing and/or generating a construction-based data object, in accordance with the process of FIG. 20 and one possible implementation of the disclosed technology.

Features, aspects, and advantages of the presently disclosed technology may be better understood with regard to the following description, appended claims, and accompanying drawings, as listed below. The drawings are for the purpose of illustrating example embodiments, but those of ordinary skill in the art will understand that the technology disclosed herein is not limited to the arrangements and/or instrumentality shown in the drawings.

### DETAILED DESCRIPTION

The following disclosure refers to the accompanying figures and several example embodiments. One of ordinary skill in the art should understand that such references are for the purpose of explanation only and are therefore not meant to be limiting. Part or all of the disclosed systems, devices, and methods may be rearranged, combined, added to, and/or removed in a variety of manners, each of which is contemplated herein.

### I. Example Network Configuration

As one possible implementation, this software technology may include both front-end software running on one or more end-user devices that are accessible to users of the software technology and back-end software running on a back-end computing platform (sometimes referred to as a “cloud” platform or a “data” platform) that interacts with and/or drives the front-end software, and which may be operated (either directly or indirectly) by a provider of the front-end client software (e.g., Procore Technologies, Inc.). As another possible implementation, this software technology may include front-end client software that runs on end-user devices without interaction with a back-end platform (e.g., a native software application, a mobile application, etc.). The software technology disclosed herein may take other forms as well.

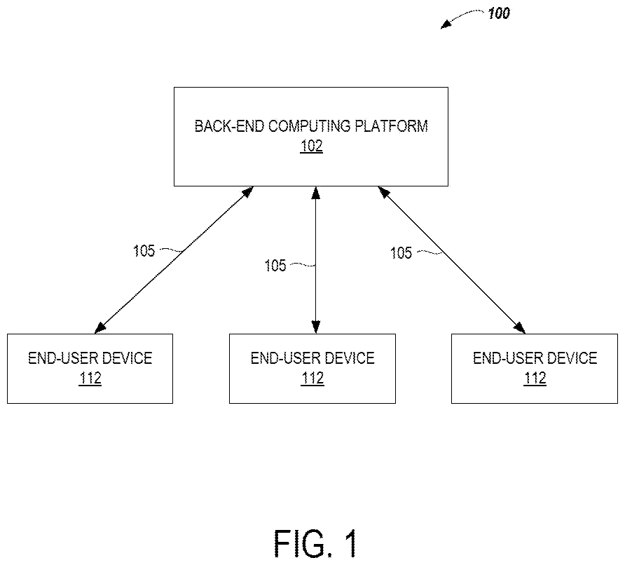

Turning now to the figures, FIG. 1 depicts an example network configuration 100 in which example embodiments of the present disclosure may be implemented. As shown in FIG. 1, the network configuration 100 includes an example back-end computing platform 102 that may be communicatively coupled to one or more client stations, depicted here, for the sake of discussion, as three end-user devices 112.

In practice, the back-end computing platform 102 may generally comprise some set of physical computing resources (e.g., processors, data storage, communication interfaces, etc.) that are utilized to implement the new software technology discussed herein. This set of physical computing resources may take any of various forms. As one possibility, the back-end computing platform 102 may comprise cloud computing resources that are supplied by a third-party provider of “on demand” cloud computing resources, such as Amazon Web Services (AWS), Amazon Lambda, Google Cloud Platform (GCP), Microsoft Azure, or the like. As another possibility, the back-end computing platform 102 may comprise “on-premises” computing resources of the organization that operates the back-end computing platform 102 (e.g., organization-owned servers).

As yet another possibility, the back-end computing platform 102 may comprise one or more dedicated servers have been provisioned with software for carrying out one or more of the computing platform functions disclosed herein, including but not limited to functions related to generating one or more of data objects, public conversation threads, limited conversation threads, or combinations thereof, facilitating conversations and/or data sharing, via the end-user devices 112, among other communications related functions. The one or more computing systems of the back-end computing platform 102 may take various other forms and be arranged in various other manners as well.

In turn, end-user devices 112 may take any of various forms, examples of which may include a desktop computer, a laptop, a netbook, a tablet, a smartphone, and/or a personal digital assistant (PDA), among other possibilities.

As further depicted in FIG. 1, the back-end computing platform 102 may be configured to communicate with the end-user devices 112 over respective communication paths 105. Each communication path 105 between the back-end computing platform 102 and an end-user device 112 may generally comprise one or more communication networks and/or communications links, which may take any of various forms. For instance, each respective communication path 105 with the back-end computing platform 102 may include any one or more of point-to-point links, Personal Area Networks (PANs), Local-Area Networks (LANs), Wide-Area Networks (WANs) such as the Internet or cellular networks, cloud networks, and/or operational technology (OT) networks, among other possibilities. Further, the communication networks and/or links that make up each respective communication path 105 with the back-end computing platform 102 may be wireless, wired, or some combination thereof, and may carry data according to any of various different communication protocols. Although not shown, the respective communication paths with the back-end computing platform 102 may also include one or more intermediate systems. For example, it is possible that the back-end computing platform 102 may communicate with a given end-user device 112 via one or more intermediary systems, such as a host server (not shown). Many other configurations are also possible.

Although not shown in FIG. 1, the back-end computing platform 102 may also be configured to receive data from one or more external data sources that may be used to facilitate functions related to the processes disclosed herein. For example, the back-end computing platform 102 may be configured to generate conversation threads and facilitate conversations thereon, as discussed herein.

It should be understood that network configuration 100 is one example of a network configuration in which embodiments described herein may be implemented. Numerous other arrangements are possible and contemplated herein. For instance, other network configurations may include additional components not pictured and/or more or less of the pictured components.

### II. Example Computing Devices

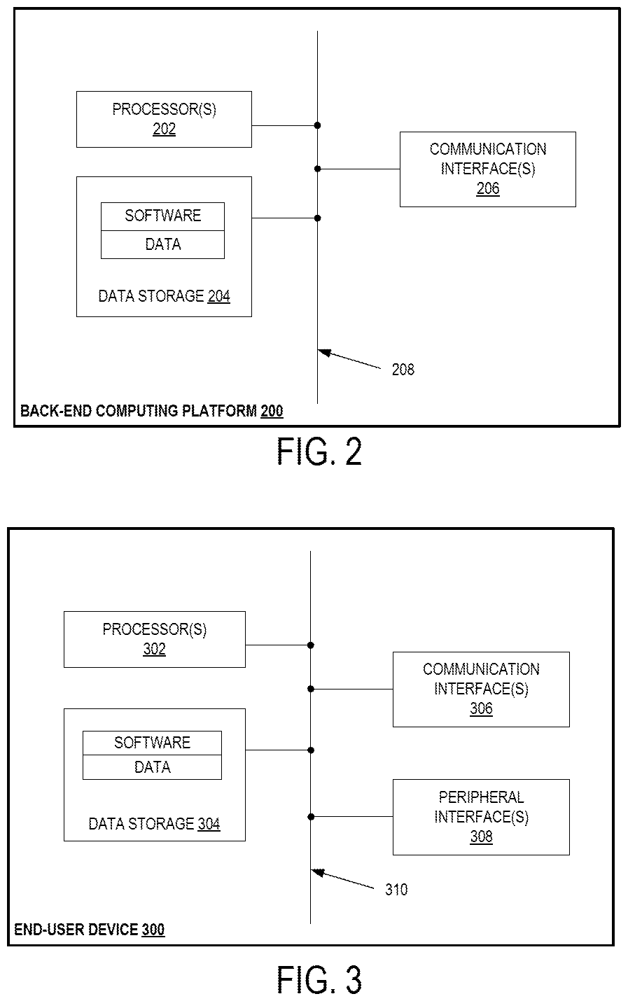

FIG. 2 is a simplified block diagram illustrating some structural components that may be included in an example computing platform 200. The example computing platform 200 could serve as, for instance, the back-end computing platform 102 of FIG. 1 that may be configured to automatically generate content for construction-based data objects, utilizing machine-learning models. In line with the discussion above, the computing platform 200 may generally comprise one or more computer systems (e.g., one or more servers), and these one or more computer systems may collectively include at least one or more processors 202, a data storage 204, and one or more communication interfaces 206, all of which may be communicatively linked by a communication link 208 that may take the form of a system bus, a communication network such as a public, private, or hybrid cloud, or some other connection mechanism.

The one or more processors 202 may comprise one or more processor components, such as general-purpose processors (e.g., a single- or multi-core microprocessor), special-purpose processors (e.g., an application-specific integrated circuit or digital-signal processor), programmable logic devices (e.g., a field programmable gate array), controllers (e.g., microcontrollers), and/or any other processor components now known or later developed. In line with the discussion above, it should also be understood that the one or more processors 202 could comprise processing components that are distributed across a plurality of physical computing resources connected via a network, such as a computing cluster of a public, private, or hybrid cloud.

In turn, the data storage 204 may comprise one or more non-transitory computer-readable storage mediums that are collectively configured to store (i) program instructions that are executable by the one or more processors 202 such that the computing platform 200 is configured to perform some or all of the disclosed functions and (ii) data that may be received, derived, or otherwise stored, for example, in one or more databases, file systems, or the like, by the computing platform 200 in connection with the disclosed functions. In this respect, the one or more non-transitory computer-readable storage mediums of the data storage 204 may take various forms, examples of which may include volatile storage mediums such as random-access memory, registers, cache, etc. and non-volatile storage mediums such as read-only memory, a hard-disk drive, a solid-state drive, flash memory, an optical-storage device, etc. In line with the discussion above, it should also be understood that the data storage 204 may comprise computer-readable storage mediums that are distributed across a plurality of physical computing resources connected via a network, such as a storage cluster of a public, private, or hybrid cloud. Data storage 204 may take other forms and/or store data in other manners as well.

The one or more communication interfaces 206 may be configured to facilitate wireless and/or wired communication with external data sources and/or end-user devices, such as the end-user devices 112 in FIG. 1. Additionally, in an implementation where the computing platform 200 comprises a plurality of physical computing resources connected via a network, the one or more communication interfaces 206 may be configured to facilitate wireless and/or wired communication between those physical computing resources (e.g., between computing and storage clusters in a cloud network). As such, the one or more communication interfaces 206 may take any suitable form for carrying out these functions, examples of which may include an Ethernet interface, a serial bus interface (e.g., Firewire, USB 3.0, etc.), a chipset and antenna adapted to facilitate wireless communication and/or any other interface that provides for wireless communication (e.g., Wi-Fi communication, cellular communication, short-range wireless protocols, etc.) and/or wired communication, among other possibilities. The one or more communication interfaces 206 may also include multiple communication interfaces of different types. Other configurations are possible as well.

Although not shown, the computing platform 200 may additionally include one or more interfaces that provide connectivity with external user-interface equipment (sometimes referred to as “peripherals”), such as a keyboard, a mouse or trackpad, a display screen, a touch-sensitive interface, a stylus, a virtual-reality headset, speakers, etc., which may allow for direct user interaction with the computing platform 200.

It should be understood that the computing platform 200 is one example of a computing platform that may be used with the embodiments described herein. Numerous other arrangements are possible and contemplated herein. For instance, other computing platforms may include additional components not pictured and/or more or less of the pictured components.

Turning now to FIG. 3, a simplified block diagram is provided to illustrate some structural components that may be included in an example end-user device 300, such as an end-user device 112 described above with reference to FIG. 1 and/or one or more client stations associated with the computing platform 200. As shown in FIG. 3, the end-user device 300 may include one or more processors 302, data storage 304, one or more communication interfaces 306, and one or more user-interface components 308, all of which may be communicatively linked by a communication link 310 that may take the form of a system bus or some other connection mechanism. Each of these components may take various forms.

The one or more processors 302 may comprise one or more processing components, such as general-purpose processors (e.g., a single- or a multi-core CPU), special-purpose processors (e.g., a GPU, application-specific integrated circuit, or digital-signal processor), programmable logic devices (e.g., a field programmable gate array), controllers (e.g., microcontrollers), and/or any other processor components now known or later developed.

In turn, the data storage 304 may comprise one or more non-transitory computer-readable storage mediums that are collectively configured to store (i) program instructions that are executable by the processor(s) 302 such that the end-user device 300 is configured to perform certain functions related to interacting with and accessing services provided by a computing platform, such as the example computing platform 200 described above with reference to FIG. 2, and (ii) data that may be received, derived, or otherwise stored, for example, in one or more databases, file systems, repositories, or the like, by the end-user device 300, related to interacting with and accessing the services provided by the computing platform. In this respect, the one or more non-transitory computer-readable storage mediums of the data storage 304 may take various forms, examples of which may include volatile storage mediums such as random-access memory, registers, cache, etc., and non-volatile storage mediums such as read-only memory, a hard-disk drive, a solid-state drive, flash memory, an optical-storage device etc. The data storage 304 may take other forms and/or store data in other manners as well.

The one or more communication interfaces 306 may be configured to facilitate wireless and/or wired communication with other computing devices. The one or more communication interfaces 306 may take any of various forms, examples of which may include an Ethernet interface, a serial bus interface (e.g., Firewire, USB 3.0, etc.), a chipset and antenna adapted to facilitate wireless communication, and/or any other interface that provides for any of various types of wireless communication (e.g., Wi-Fi communication, cellular communication, short-range wireless protocols, etc.) and/or wired communication. Other configurations are possible as well.

The end-user device 300 may additionally include or have interfaces for one or more user-interface components 308 that facilitate user interaction with the end-user device 300, such as a keyboard, a mouse, a trackpad, a display screen, a touch-sensitive interface, a stylus, a virtual-reality headset, and/or one or more speaker components, among other possibilities.

It should be understood that the end-user device 300 is one example of an end-user device that may be used to interact with a computing platform as described herein. Numerous other arrangements are possible and contemplated herein. For instance, in other embodiments, the end-user device 300 may include additional components not pictured and/or more or fewer of the pictured components. Further, the end user device 300 of FIG. 3 and/or the end user device 112 of FIG. 1 may be examples of client devices, utilized by users of the computing platform 200.

### III. Example Operations

As mentioned above, Procore Technologies has continued to develop software technology related to construction management and data management amongst platform users associated with such managed projects. Disclosed herein is new software technology that is generally directed to training a machine-learning model, for use with a computing platform, utilizing the trained machine-learning model to automatically generate content for one or more construction-based data objects, and, optionally, utilizing one or more of data collected from automatic content generation, construction-based training data sets, or combinations thereof to automatically generate complete construction-based data objects. As disclosed herein, an “ongoing construction project,” may refer to a construction project that is currently being monitored by one or more entities (e.g., contractors, owners, supervisors, workers, etc.). Accordingly, such ongoing construction projects may be in any phase of the construction project, such as, but not limited to, a planning phase, a design phase, a logistics phase, a construction phase, an implementation phase, a finalization phase, among other known project phases for a construction project.

### i. Systems and Methods of Automatically Generating Content for Construction-Based Data Objects

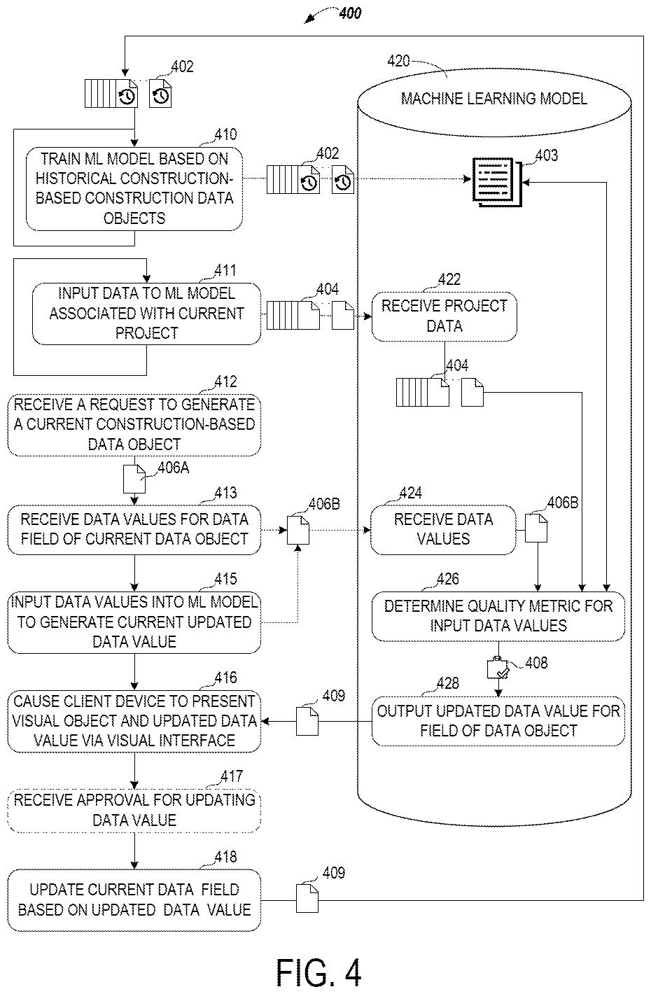

Turning now to FIG. 4, an example flow diagram is illustrated for a method 400 carried out by a computing platform, which may take the form of one or more of the back-end computing platform 102, 200, the end-user device(s) 300, or combinations thereof. The method 400 includes, at block 410, training a machine-learning model 420 by carrying out a machine learning process on a training data set 403, which includes a plurality of historical construction-based data objects 402. Each of the historical construction-based data objects 402 includes at least one data field comprising respective historical data values and a respective indication of a resolution of the historical construction-based data object. A resolution of a given member of the historical construction-based data objects 402 is an indication of an action or outcome that occurred during entrance and/or completion of data entry associated with the given historical construction-based data objects 402.

In some examples, the method of 400 further includes block 411, wherein ongoing construction-based data 404, associated with a current construction project, is input to the machine-learning model 420 and received by the machine-learning model 420 (block 422). The ongoing construction-based data 404 may be processed by the machine-learning model 420, in view of the training data set 403, such that the machine-learning model 420 determines contextual information associated with the ongoing construction project such as, but not limited to, characteristics of parties to the construction project, progress of the construction project, status of the construction project, characteristics of the construction project as evaluated against similar historical construction projects, among other things.

At block 412, the method 400 includes receiving a request to generate a current construction-based data object 406A associated with an ongoing construction project. In response to the request of block 412, the computing platform 200 may generate the current construction-based data object 406A and/or populate one or more data fields of the current construction-based data object 406A. In some examples, the current construction-based data object 406A may be generated based on a request provided to the computing system 200 via, for example, a client station, such as an end-user device 300.

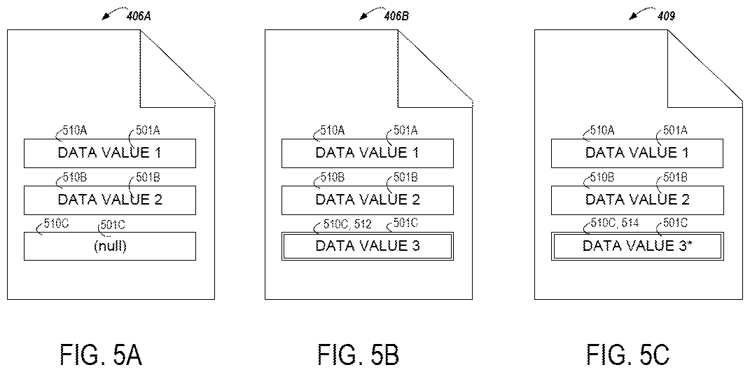

The method 400 includes receiving one or more data values 510 for one or more current data fields of the current construction based data object 406A, as illustrated in block 413. As illustrated in the example graphic representations of data object(s) 406A, 406B, 409, of FIGS. 5A, 5B, 5C, respectively, each of the data objects 406A, 406B, 409 include a plurality of data fields 501. “ ” While illustrated as each having three data fields 501A, 501B, 501C, each of the data objects 406A, 406B, 409 and/or any other data objects discussed herein may include any number of data fields. Further, each of the data fields 406A, 406B, 409 include data values 510 each associated with a data field 501. The form of the data fields 510, as depicted in FIGS. 5A-C as text entries are only used to show a location wherein a data value 501 can change during alterations to a data object 406A, 406B, 409 (e.g., the text indicative of the data values 501 can change in some way). Accordingly, the way in which a data value is altered is based on the type of data that is input to the data field and the depictions of data fields and values in FIGS. 5A, 5B, 5C are not limiting. While illustrated as changeable or editable text entries into text fields in FIGS. 5A-C, the data values 510 may take the form of any type of data held in a data field, such as, but not limited to, text data, contextual data, image data, audio data, video data, numerical data, among other data types and/or formats known in the art.

FIG. 5A is representative of the current data object 406A, as generated at, for example, the step of block 412 and, in this example, the data field 501C has a data value that is empty or null. FIG. 5B is representative of the current data object 406B after the computing platform 200 receives one or more data values 512 for input to the current data field 501C as an input data value 512. FIG. 5C is representative of a current updated data value 514 for a current updated data object 409, which will be discussed in more detail, below.

Returning now to FIG. 4, the method further includes inputting one or more data values for the one or more data fields 501 of the current data object 406B into the machine learning model 420, as illustrated in block 415. To that end, the machine learning model 420 is configured to receive, as input, one or more input data values for one or more data fields of a construction-based data object, wherein the construction-based data object is associated with a construction project.

While the machine learning model 420 is illustrated and described herein as receiving a “current” construction-based data object associated with an “ongoing” construction project as the input construction-based data object, it is certainly contemplated that the machine learning model 420 may receive other data objects as input, such as, but not limited to, historical construction based data objects, predicted construction based data objects, hypothetical construction based data objects, among other known data objects for which automatic content generation is desired.

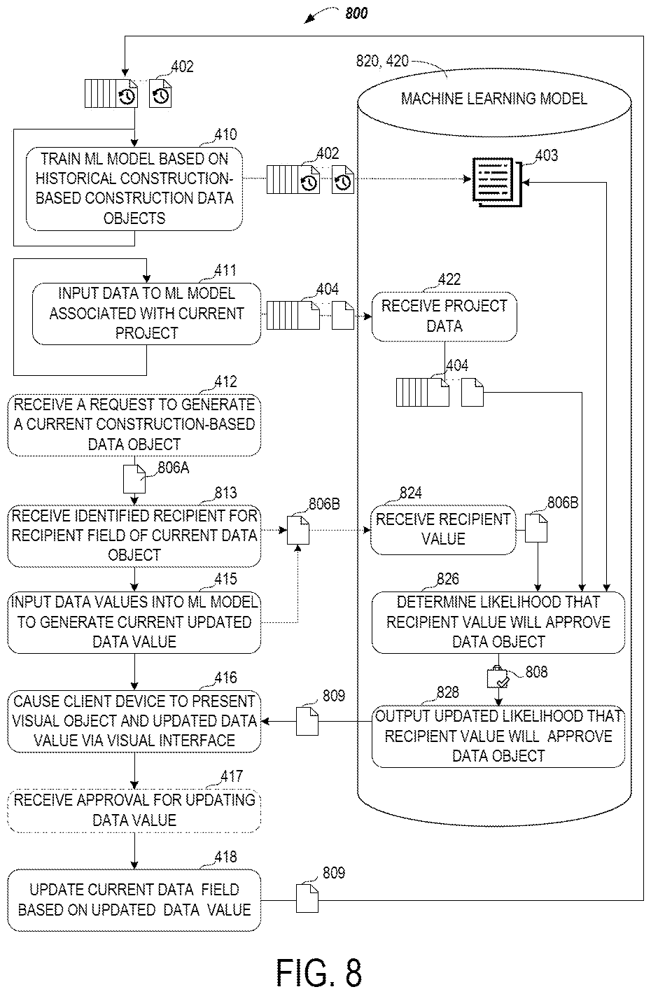

At block 426, based on an evaluation of the received data values of the current construction-based data object 406B, in view of the training data set 403 and, optionally, the ongoing construction data 404, the machine learning model 420 may be configured to determine a quality metric 406 for the input data values to the machine learning model 420. A “quality metric.” as defined herein, refers to any ranking, predicted qualitative determination, a predicted quantitative determination, an objective determination, a predicted subjective determination, a likelihood of success, a likely timeframe for completion, a likelihood of responsiveness by a party, and the like. The quality metric is any useful indicator of value of input data to the machine learning model, when said data and its associated data object are evaluated against historical data objects and their respective resolutions. Quality metrics may be useful tools and/or data signifiers for evaluating the input data for the purpose of automatic content generation. Examples of more specific quality metrics and their use, as associated with construction-based data objects, are provided, below, with reference to FIGS. 8-19C.

The machine learning model 420 is further configured to output one or more of the updated current construction-based data object 409, the updated data value(s) therein, or combinations thereof, as illustrated in block 428.

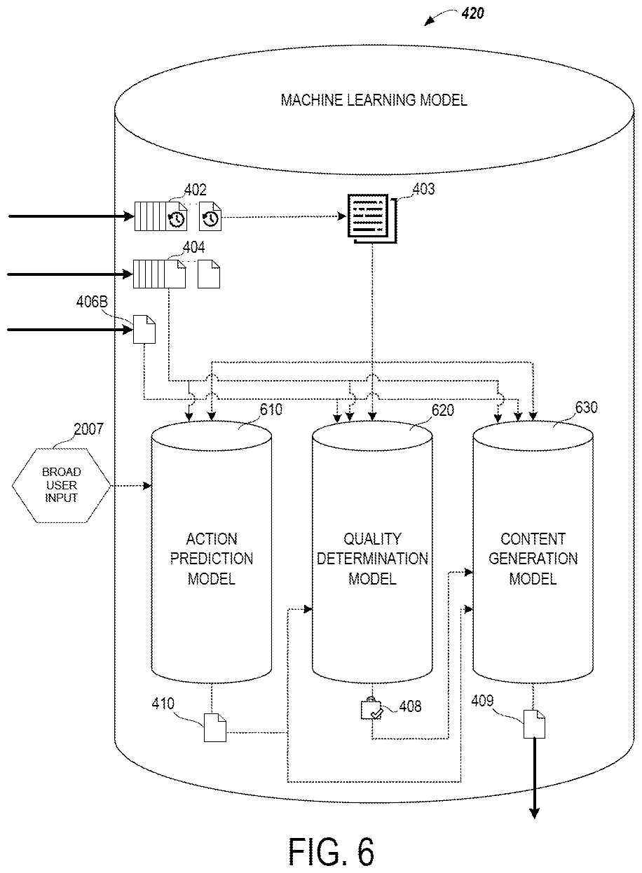

FIG. 6 is a graphic diagram for the machine-learning model 420, components thereof, and associated data throughput. Machine-learning model 420 may be implemented by one or more computing devices of the computing platform 200, the end-user devices 300, or combinations thereof. In some examples, inputs to the machine-learning model 420 may be any construction project data related to past completed or other ongoing construction projects, which may be useful in training the machine-learning model 420 to recognize context and language used within the confines of a computing platform 200 running a construction management software service, or any applications thereof.

As illustrated in FIG. 6, an example implementation of the machine learning model 420 may include one or more sub-models, such as, but not limited to an action prediction model 610, a quality determination model 620, and a content generation model 630. While depicted as separate machine-learning models in FIG. 6, the models 610, 620, 630 are illustrated not to limit the model 420 to this configuration, but to describe functions of the machine-learning model 420 and, as such, each of the models 610, 620, 630 may be separate models associated with the computing platform 200, each of the models 610, 620, 630 may be illustrative of certain functions of the machine-learning model 420, and/or each of the models 610, 620, 630 may be combined and/or functionally interchangeable, for the purposes of automatic content generation for construction-based data objects.

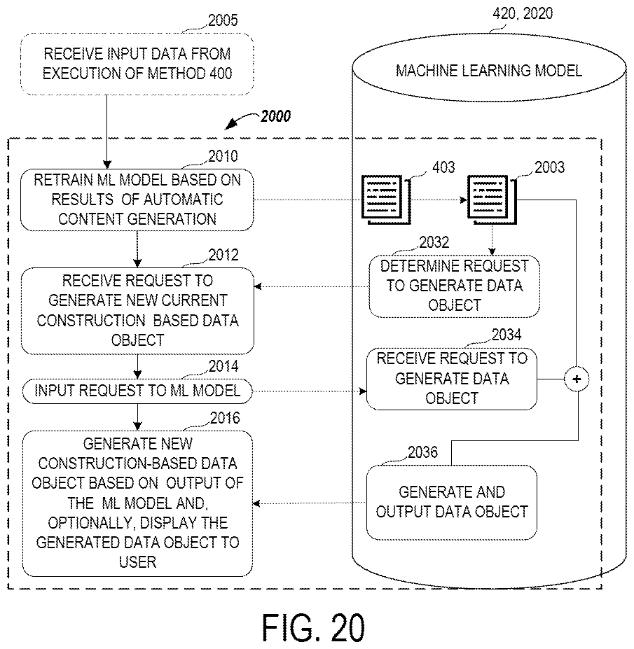

The quality determination model 620 may be utilized by the computing platform 200 and/or the machine-learning model 420 to receive, as input, one or more of the training data set 403, the ongoing construction-based data 404, and the input values and/or associated data object 406B, or combinations thereof. Further, the quality determination model 620 may be utilized for evaluating the input for the purposes of determining the quality metric 408. Further, the content generation model 630 may be configured to receive, as input, one or more of the training data set 403, the ongoing construction-based data 404, the input values and/or associated data object 406B, the quality metric 408, or combinations thereof. The content generation model 630 may be utilized to evaluate the input, for the purposes of determining new or updated values for the updated current construction-based data object 409. Further, details regarding the action prediction model 610 will be described in more detail, below, with respect to FIG. 20.

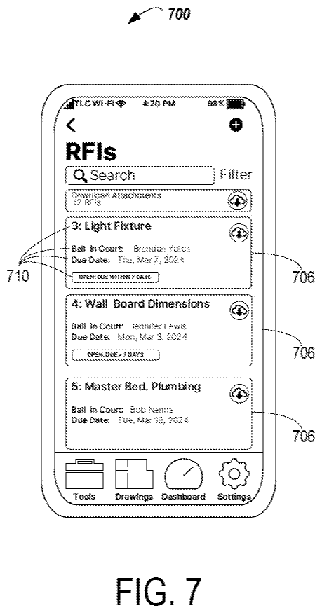

Returning to FIG. 4, the method 400 further includes, at block 416, causing a client device (e.g., an end-user device 300) to present a visual interface that may be usable for viewing an indication of one or more of the current construction-based data object, an indication of the current updated value, or combinations thereof. An example of such a visual interface 700 is illustrated in FIG. 7, wherein the interface 700 shows an RFI application including a series of indications of construction-based data objects 706 and associated indications of data fields 710 for the respective construction based data objects 706. While depicted as an interface 700 for organizing, viewing, and/or otherwise interacting with RFIs, it is certainly contemplated that the interface 700 may be usable for organizing, viewing, and/or otherwise interacting with one or more other types of construction-based data objects.

Returning to FIG. 4, the method 400 may include an optional step, block 417, of receiving, by the computing platform 200 from a user, a confirmation to alter the at least one current data field, based on the current updated value. Further, the method includes updating the one or more current data fields of the current construction-based data object, based on the current updated data value provided based on the output of the machine learning model 420, as illustrated in block 418. In the optional examples wherein block 417 is executed, the updating operations at block 418 may be performed in response to the confirmation to alter at least one current data field.

Upon execution of, for example, block 418, any of the ongoing construction project data 404, the construction based data object(s) 406A, 406B, 409, quality metric(s) 408, and any alterations thereof may be received at block 410, wherein said data is utilized in further training and/or retraining the machine learning model 420, for future use in automatically generating content for construction-based data objects.

### ii. Utilizing Systems and Methods of Automatically Generating Content to Intelligently Select Recipients for Construction-Based Data Objects

Turning now to FIG. 8, a flowchart for a method 800 for automatically generating content for a construction-based data object is illustrated. The method 800 of FIG. 8 includes common and similar elements to those of the method 400 of FIG. 4. Common elements are labelled having the same reference numbers to those of FIG. 4, although the data, input, and/or output associated with the common elements, in FIG. 8, may be of a more specific form. Similar elements are labelled having the same two least significant digits as its similar element of the method 400 of FIG. 4 (e.g., block 813 is similar to block 413).

The method 800 includes blocks 410 and 411, wherein description of both is discussed, above, with respect to FIG. 4. Further still, a machine learning model 820 may include similar elements to that of the machine learning model 420 and/or the machine learning model 420 may be capable of executing the functions, disclosed herein, of the machine learning model 820.

The method 800 may be useful for automatically generating content for data object 806 that includes, at least, a field for a recipient or respondent to the data object 806. The method 800 may be useful in assisting a user in choosing a recipient. In one example, the party that generates the construction-based data object 806 may initially enter a plurality of recipients to the construction-based data object 806; however, as discussed above, entering many recipients may lessen the likelihood of response to the construction-based data object 806. Then, via use of the machine-learning model 820, the method 800 may determine one or more recipients of the list of recipients who is likeliest to respond to the data object, most qualified to respond to the data object, or combinations thereof. Then, the method 800, carried out by the computing platform 200, may populate the recipient data field of the construction-based data object 806 based on output of the machine-learning model 820.

As another possibility, the party that generates the construction-based data object 806 may not initially enter any recipients in the recipient data field. In these situations, the model 820 may populate the recipient data field that is mostly likely to respond, as determined by the model 820.

To that end, at block 412, the method 800 includes receiving a request to generate a current construction-based data object 806A associated with an ongoing construction project. In response to the request of block 412, the computing platform 200 may generate the current construction-based data object 806A and/or populate one or more recipient data fields of the current construction-based data object 806A. In some examples, the current construction-based data object 806A may be generated based on a request provided to the computing system 200 via, for example, a client station, such as an end-user device 300.

The method 800 includes receiving one or more data values for one or more recipient data fields of the current construction-based data object 806, as illustrated in block 813. The recipient data field(s) may be any data field that contains, as data values, data indicative of a prospective recipient of and/or respondent to the construction-based data object 806. The data value input for the recipient value may include a plurality of identified recipients for the recipient field.

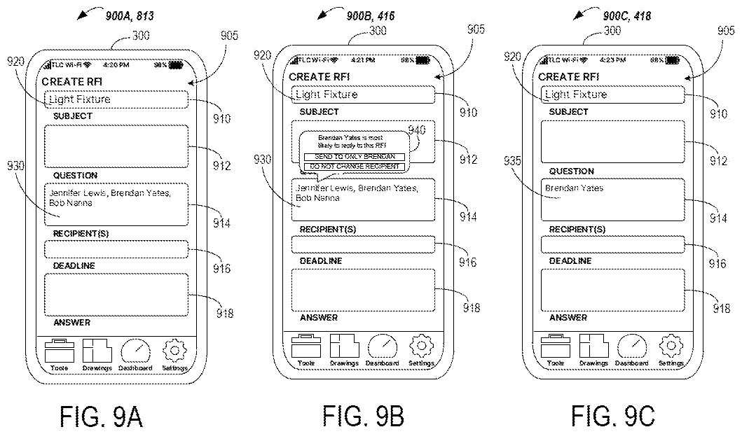

An example of a visual interface 900 is illustrated in FIG. 9A-C, wherein the interface 900 shows an RFI application. The method 800 may be performed to provide updated data values for a recipient field for a data object presented and/or generated via the RFI application. As illustrated, the interface includes an indication of a construction-based data object 905, represented as text data for an RFI. The indication of a construction-based data object 905 comprises, for example, a subject field 910 indicative of a subject for the RFI, a question field 912 for text data values for a question for the RFI, a recipient field 914 for indicating one or more recipients of the RFI, a deadline field 916 for indicating a deadline for a recipient to provide an answer in response to the RFI, and an answer field 918 for storing text data values for an answer to the question data of the question field. While the examples of FIGS. 9A-C illustrate utilization of the method 800 for automatically generating content for an RFI, the method 800 certainly is not limited to use in generating content for RFIs and may be utilized in generating content for any construction-based data object.

FIG. 9A may be indicative of a first state of the visual interface 900A, wherein a user may input recipient data values 930 to the recipient field 914 and, accordingly, the first state of the visual interface 900A may be a state of the interface at block 813 of the method 800, wherein said input recipient data values 930 are received by the computing system 200.

The method further includes inputting one or more data values for the one or more recipient data fields of the current data object 806B into the machine learning model 820, as illustrated in block 415. To that end, the machine learning model 820 is configured to receive, as input, the one or more recipient data values for one or more recipient data fields of a construction-based data object, wherein the construction-based data object is associated with a construction project.

At block 826, based on an evaluation of the received data values of the current construction-based data object 806B, in view of the training data set 403 and, optionally, the ongoing construction data 404, the machine learning model 820 may be configured to determine a quality metric 808 for the input data values to the machine learning model 820. In one example of the method 800, the quality metric 808 is a likelihood that each of the plurality of recipients for the recipient field will respond to the construction-based data object 806B. In another example of the method 800, the quality metric 808 is a perceived qualification, determined by the machine-learning model 820, for each of the plurality of recipients for the recipient field, to adequately respond to the construction-based data object 806B.

Based on an evaluation of the input data, in view of one or more of the quality metric 808, the training data 403, the ongoing construction project data 404, or combinations thereof, the machine learning model 820 is further configured to output one or more of the updated current construction-based data object 809, the updated data value(s) therein, or combinations thereof, as illustrated in block 828. This output data may be data indicative of a member of the plurality of recipients for the recipient field that is most likely to respond to the construction-based data object 806 and/or a member of the plurality of recipients for the recipient field that is most qualified to respond to the construction-based data object 806B.

In situations where the recipient data field is initially empty and the model 820 adds or suggests a mostly-likely recipient, as mentioned above, the input data used by the model may include data values from the other fields of the construction-based data object 806B. For example, based on data values that the initiating user entered in the “subject” and/or “question” data fields (among other possibilities) of the construction-based data object 806B, the model may predict a most likely recipient to answer the RFI.

Upon completion of one or more of blocks 415, 824, 826, and 828, the method 800 proceeds to block 416, wherein the computing system 200 causes the client device 200 to present a visual representation of the data object (e.g., the indication of the construction-based data object 905) and an updated data value, via a second state of the visual interface 900B, as illustrated in FIG. 9B. As illustrated, an updated data value may include a data entry for updating the recipient field 914 and the user of the end-user device 300 may be presented with an indication of an updated data value, via a suggestion 940, which may include data inputs for selection by the user. The updated data value, based on the output of the machine learning model 820, may be, for example, an indication or notification of a likelihood that an intended recipient will reply to the construction-based data object, a suggestion of an alternative recipient for input to the recipient field, among other alterations or populations of data values stored in the recipient field or associated data fields.

In this example, the suggestion 940 may include additional data that is derived from or otherwise indicative of or associated with the quality metric 808. In the present example, the machine-learning model 820 has determined, via evaluating the input data values 806B, in view of, at least, the training data set 403, that “Brendan Yates” is the most likely of the listed recipients to respond with an entry for the answer field 918.

The method 800 may include an optional step, block 417, of receiving, by the computing platform, a confirmation to alter the at least one current data field, based on the current updated value. Further, the method 800 includes updating the one or more current data fields of the current construction-based data object, based on the output of the machine learning model 820, as illustrated in block 418. In the optional examples wherein block 417 is executed, the updating of block 418 may be performed in response to the confirmation to alter the recipient data field.

In the present example and with continued reference to FIG. 9B, a user of the end user device 300 may select confirmation or non-confirmation of the proposed update to the recipient values, via user input from a data input for selection associated with the suggestion 940. For example, the suggestion 940 includes an input of “SEND TO ONLY BRENDAN” and “DO NOT CHANGE RECIPIENT;” if the user selects, via, for example, touch screen or peripheral input, “SEND TO ONLY BRENDAN,” then the method 800 will proceed to block 418.

As illustrated in FIG. 9C, which is indicative of a third state of the visual interface 900C, the user has confirmed that he/she/they accepts updating the recipient data field 914 from the original recipient data values 930 to new recipient data values 935, which is indicative of an outcome of block 418. Accordingly, based on the suggestions and data provided by the machine learning model 820, the recipient field 914 is updated with automatically generated content for the recipient field 914.

In another example implementation for utilizing automatic content generation to intelligently select one or more recipients, a recipient is input to the recipient field and, based on inputting the recipient to the machine-learning model, the systems and methods disclosed herein may assess the likelihood that the input recipient will respond to the construction-based data object. Such recipient-based generative content technologies may be particularly useful for generating content for construction-based data objects that require a response from another party, such as, but not limited to, RFIs and submittals.

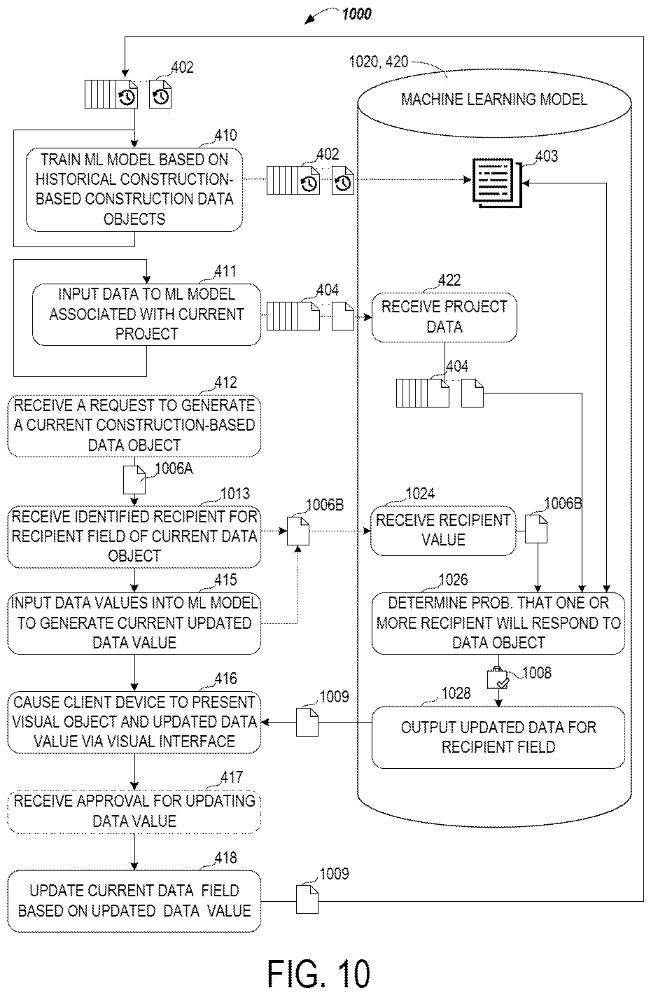

A flowchart for a method 1000 for automatically generating content for a construction-based data object 1006 is illustrated in FIG. 10. The method 1000 includes common and similar in comparison to those of the method 400 of FIG. 4. Common elements are labelled having the same reference numbers to those of FIG. 4, although the data, input, and/or output associated with the common elements, in FIG. 10, may be of a more specific form. Similar elements are labelled having a common two least significant digits as its similar element of the method 400 of FIG. 4 (e.g., block 1013 is similar to block 413).

The method 1000 includes block 410 and 411, wherein description of both is discussed, above, with respect to FIG. 4. Further still, a machine learning model 1020 may include similar elements to that of the machine learning model 420 and/or the machine learning model 420 may be capable of executing the functions, disclosed herein, of the machine learning model 1020.

The method 1000 may be useful for automatically generating content for data objects 1006 that include, at least, a field for a recipient or respondent to the data object. The method 1000 may be useful in choosing a recipient. In one example, the party that generates the construction-based data object may initially enter a recipient to the construction-based data object 1006A. Then, via use of the machine-learning model 1020, the systems and methods may determine a likelihood that an entered intended recipient will respond to the construction-based data object 1006B. Then, the systems and methods carried out by the computing platform 200 may populate a field indicative of a likelihood of response by the input recipient and, optionally, may prompt the user with a suggestion for another alternative recipient or a suggestion to alter the recipient field.

To that end, at block 412, the method 1000 includes receiving a request to generate a current construction-based data object 1006A associated with an ongoing construction project. In response to the request of block 412, the computing platform 200 may generate the current construction-based data object 1006A and/or populate one or more recipient data fields of the current construction-based data object 1006A. In some examples, the current construction-based data object 1006A may be generated based on a request provided to the computing system 200 via, for example, a client station, such as an end-user device 300.

The method 1000 includes receiving one or more data values for one or more recipient data fields of the current construction-based data object 1006, as illustrated in block 1013. The recipient data field(s) may be any data field that contains, as data values, data indicative of a prospective recipient of and/or respondent to the construction-based data object. The data value input for the recipient value may include a plurality of identified recipients for the recipient field.

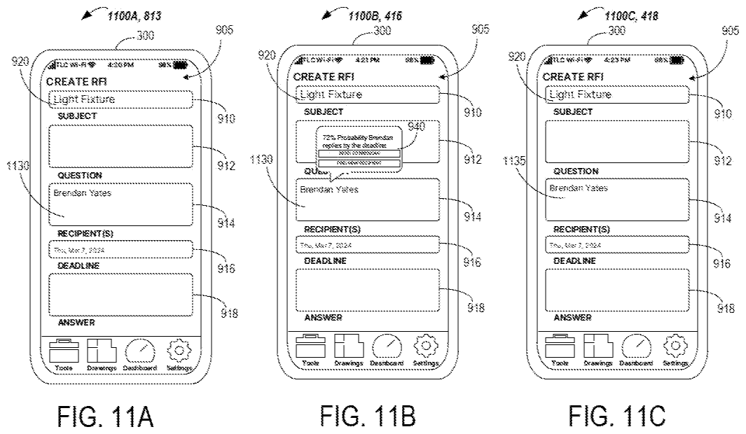

An example of a visual interface 1100 is illustrated in FIGS. 11A-C, wherein the interface 1100 shows an RFI application, wherein the method 1000 may be performed to provide updated data values for a recipient field or an associated data field indicative of a likelihood that a potential recipient responds to the construction-based data object 1006. As illustrated, the interface 1100 includes the indication of a construction-based data object 905, represented as text data for an RFI. The indication of construction-based data object 905 comprises, for example, the subject field 910, the question field 912, the recipient field 914, the deadline field 916, and the answer field 918. While the examples of FIGS. 11A-C illustrate utilization of the method 1000 for automatically generating content for an RFI, the method 1000 certainly is not limited to use in generating content for RFIs and may be utilized in generating content for any construction-based data object.

FIG. 11A may be indicative of a first state of the visual interface 1100A, wherein a user may input recipient data values 1130 to the recipient field 914 and, accordingly, the first state of the visual interface 1100A may be a state of the interface at block 1013 of the method 1000, wherein said input recipient data values 1130 are received by the computing system 200. As illustrated, the user of the end-user device 300, upon which the user inputs the input recipient data values 1130 into the indication of the construction-based data object 905.

The method further includes inputting one or more data values for the one or more recipient data fields of the current data object 1006 into the machine learning model 1020, as illustrated in block 415. To that end, the machine learning model 1020 is configured to receive, as input, the one or more recipient data values for one or more recipient data fields of a construction-based data object, wherein the construction-based data object is associated with a construction project.

At block 1026, based on an evaluation of the received data values of the current construction-based data object 1006, in view of the training data set 403 and, optionally, the ongoing construction data 404, the machine learning model 1020 may be configured to determine a quality metric 1008 for the input data values to the machine learning model 1020. In one example of the method 1000, the quality metric 1008 is a likelihood that one or more recipients input for the recipient field will respond to the construction-based data object 1006.

Based on an evaluation of the input data, in view of one or more of the quality metric 1008, the training data 403, the ongoing construction project data 404, or combinations thereof, the machine learning model 1020 is further configured to output one or more of the updated current construction-based data object 1009, the updated data value(s) therein, or combinations thereof, as illustrated in block 1028. This output data may be data indicative of a likelihood that the intended recipient of the recipient field 914 responds to the construction-based data object 806.

After the method 1000, then, performs the functions of one or more of blocks 415, 1024, 1026, and 1028, the method 1000 proceeds to block 416, wherein the computing system 200 causes the client device 200 to present a visual representation of the data object (e.g., the indication of the construction based data object 905) and an updated data value via a second state of the visual interface 1100B, as illustrated in FIG. 11B. As illustrated, an updated data value may include a likelihood that the indicated recipient responds to the construction-based data object and the user of the end-user device 300 may be presented with an indication of an updated data value, via a notification 1140, which may include data inputs for selection by the user. The updated data value, based on the output of the machine learning model 1020, may be, for example, an indication or notification of a likelihood that an intended recipient will reply to the construction-based data object, a suggestion of an alternative recipient for input to the recipient field, among other alterations or populations to data values stored in the recipient field or associated data fields.

In this example, the notification 1140 may include data that is derived from or otherwise indicative of, or associated with, the quality metric 1008. In the present example, the machine-learning model 1020 has determined, via evaluating the input data values of the construction-based data object 1006B in view of, at least, the training data set 403, that “Brendan Yates” has about a 72% chance of replying to the RFI by the given deadline.

The method 1000 may include an optional step, block 417, of receiving, by the computing platform, a confirmation to alter the at least one current data field, based on the current updated value. Further, the method 1000 includes updating the one or more current data fields of the current construction-based data object 1006B, based on the output of the machine learning model 1020, as illustrated in block 418. In the optional examples wherein block 417 is executed, the updating of block 418 may be performed in response to the confirmation to alter the recipient data field.

In the present example and with continued reference to FIG. 11B, a user of the end user device 300 may select, based on one or more new data values provided by output from the machine learning model 1020, whether to change the data values of the recipient or not, via user input from a data input for selection associated with the notification 1140. For example, the notification 1140 includes an input of “SEND TO BRENDAN” and “FIND NEW RECIPIENT;” if the user selects, via, for example, touch screen or peripheral input, “SEND TO ONLY BRENDAN,” then the method 800 will proceed to block 418. Thus, the new data values for the recipient value 1135 are similar to those of the data values 1130, as a result of the method 1000 indicating that “Brendan Yates” is likely to respond to the RFI. Alternatively, if the user selects “FIND NEW RECIPIENT,” then one or more actions may occur in response to the selection, such as, but not limited to (i) the computing platform 200 prompting a user to input an alternative recipient for the recipient field 914, (ii) utilizing the machine learning model 1020 to automatically generate an alternative recipient for the construction-based data object, or (iii) combinations thereof.

FIG. 11C is an illustration indicative of a third state of the visual interface 1100C, wherein the user has confirmed that he/she/they accepts the current value of the recipient data field 914. Accordingly, based on the suggestions and data provided by the machine learning model 1020, the recipient field 914, in this specific example, is unchanged-however, the user may have more confidence in his/her/their selection of a recipient, based on the likelihood of response data, provided via the machine learning model 1020.

### iii. Utilizing Systems and Methods of Automatically Generating Content to Intelligently Select Deadlines

Construction projects and/or tasks thereof, generally, occur on a finite time frame, wherein timely completion is important to avoid delays and associated extra costs. As illustrated above, a construction-based data object, such as an RFI, may include a deadline field, indicative of a deadline for completing at least one task of the construction-based data object and/or a task of a current construction project. In such examples, the machine-learning assisted systems and methods may be utilized for (i) determining if an input to a timeline field is achievable and/or accurate, (ii) generate an appropriate deadline for completion of the task and/or entry to the construction-based data object, (iii) suggest a new deadline for the deadline field based on knowledge of events associated with the construction project, or (iv) combinations thereof.

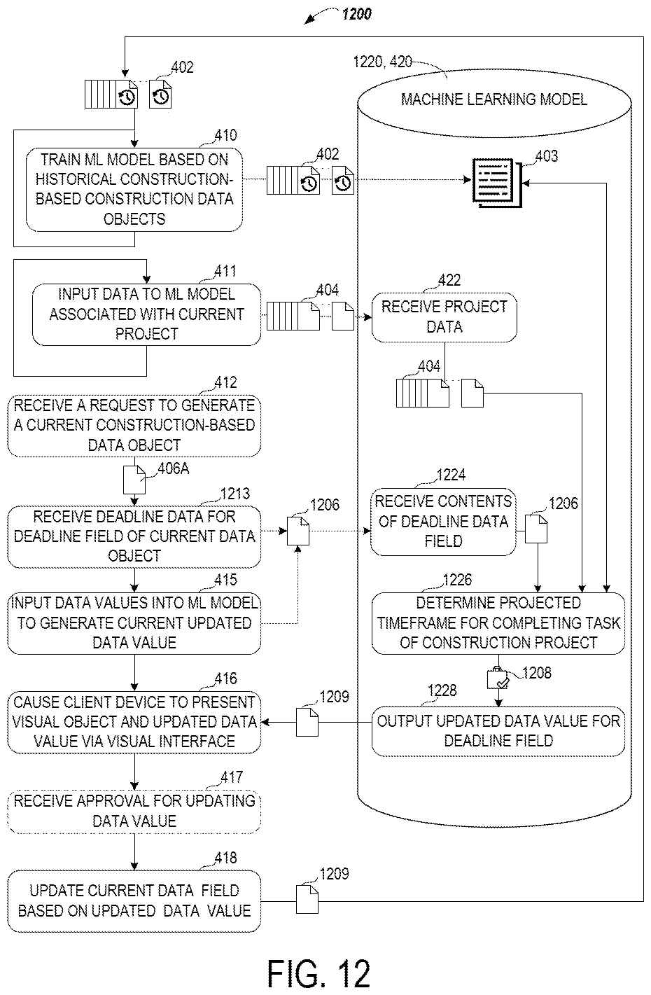

To that end, FIG. 12 is flowchart for a method 1200 for automatically generating content for a construction-based data object. The method 1200 of FIG. 12 includes common and similar elements to those of the method 400 of FIG. 4. Common elements are labelled having the same reference numbers to those of FIG. 4, although the data, input, and/or output associated with the common elements, in FIG. 12, may be of a more specific form. Similar elements are labelled having the same two least significant digits as its similar element of the method 400 of FIG. 4 (e.g., block 1213 is similar to block 413).

The method 1200 includes block 410 and 411, wherein description of both is discussed, above, with respect to FIG. 4. Further still, a machine learning model 1220 may include similar elements to that of the machine learning model 420 and/or the machine learning model 420 may be capable of executing the functions, disclosed herein, of the machine learning model 1220.

The method 1200 may be useful for automatically generating content for data objects 1206 that include, at least, a field for a deadline for response to the construction-based data object. The method 1200 may be useful in choosing or altering a deadline for the response to the construction-based data object 1206. In one example, the party that generates the construction-based data object may initially enter a deadline to the construction-based data object 1206A. Then, via use of the machine-learning model(s) 1220, the systems and methods may determine a likelihood that an entered intended recipient will respond to the construction-based data object 1206B, by the input deadline. Then, the systems and methods carried out by the computing platform 200 may populate a field indicative of a deadline, with a new deadline or the same deadline, and, optionally, may prompt the user with a suggestion for an alternative deadline or a suggestion to alter the deadline.

To that end, at block 412, the method 1200 includes receiving a request to generate a current construction-based data object 1206A associated with an ongoing construction project. In response to the request of block 412, the computing platform 200 may generate the current construction-based data object 1206A and/or populate one or more deadline data fields of the current construction-based data object 1206A. In some examples, the current construction-based data object 1206A may be generated based on a request provided to the computing system 200 via, for example, a client station, such as an end-user device 300.

The method 1200 includes receiving one or more data values for one or more deadline data fields of the current construction-based data object 1206, as illustrated in block 1213. The deadline data field(s) may be any data field that contains, as data values, data indicative of a deadline for response to the construction-based data object or a deadline for a task of the construction project.

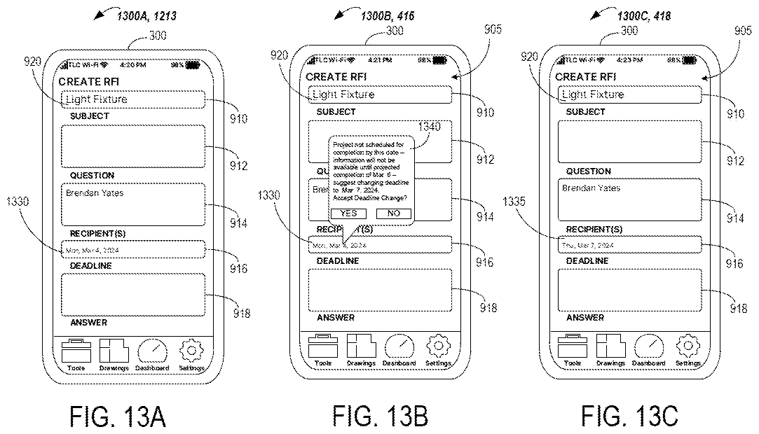

An example of a visual interface 1300 is illustrated in FIG. 13A-C, wherein the interface 1300 shows an RFI application, with which the method 1200 may be performed to provide updated data values for a deadline field or an associated data field indicative of information associated with a deadline of the construction-based data object. As illustrated, the visual interface 1300 includes the indication of a construction-based data object 905, represented as text data for an RFI. The indication of construction-based data object 905 comprises, for example, the subject field 910, the question field 912, the recipient field 914, the deadline field 916, and the answer field 918. While the examples of FIGS. 13A-C illustrate utilization of the method 1200 for automatically generating content for an RFI, the method 1200 certainly is not limited to use in generating content for RFIs and may be utilized in generating content for any construction-based data object.

FIG. 13A may be indicative of a first state of the visual interface 1300A, wherein a user may input deadline data values 1330 to the deadline field 916 and, accordingly, the first state of the visual interface 1300A may be a state of the interface at block 1213 of the method 1200, wherein said input deadline data values 1330 are received by the computing system 200.

The method further includes inputting one or more data values, for the one or more deadline data fields of the current data object 1206, into the machine learning model 1220, as illustrated in block 415. To that end, the machine learning model 1220 is configured to receive, as input the one or more deadline data values for one or more deadline data fields of a construction-based data object, wherein the construction-based data object is associated with a construction project, as illustrated in block 1224.

At block 1226, based on an evaluation of the received data values of the current construction-based data object 1206, in view of the training data set 403 and, optionally, the ongoing construction data 404, the machine learning model 1220 may be configured to determine a quality metric 1208 for the input data values to the machine learning model 1220. In one example of the method 1200, the quality metric 1208 is a projected timeframe for completing the at least one task of the current construction project and/or the construction-based data object 1206 thereof.

Based on an evaluation of the input data, in view of one or more of the quality metric 1208, the training data 403, the ongoing construction project data 404, or combinations thereof, the machine learning model 1220 is further configured to output one or more of the updated current construction-based data object 1209, the updated data value(s) therein, or combinations thereof, as illustrated in block 1228. This output data may be data indicative of a likelihood that the intended recipient of the recipient field 914 responds to the construction-based data object 806 by the deadline indicated by the input deadline data values 1330 and/or the output data may be data indicative of suggestions for an updated deadline data value 1335.

After the method 1200 performs the functions of one or more of blocks 415, 1224, 1226, and 1228, the method 1200 proceeds to block 416, wherein the computing system 200 causes the client device 200 to present a visual representation of the data object (e.g., the indication of the construction based data object 905) and an updated data value, via a second state of the visual interface 1300B, as illustrated in FIG. 13B. As illustrated, an updated data value may include a likelihood that the indicated recipient is likely to respond or is capable of responding to the construction-based data object by the input deadline and the user of the end-user device 300 may be presented with an indication of an updated data value for the deadline, via a notification 1340, which may include data inputs for selection by the user.

The updated data value, based on the output of the machine learning model 1220, may be, for example, an indication or notification of a likelihood that an intended recipient will be unable to respond to the construction-based data object, by the input deadline, due to circumstances associated with the ongoing construction project. In some examples, the updated data values may include a suggestion of an alternative deadline for input to the deadline field, among other alterations or populations to data values stored in the deadline field or associated data fields.

In this example, the notification 1340 may include data that is derived from or otherwise indicative of, or associated with, the quality metric 1208. In the present example, the machine-learning model 1220 has determined, via evaluating the input data values of the construction-based data object 1006B, in view of, at least, the training data set 403, that the “project [is] not scheduled for completion by [deadline]” and “information will not be available until projected completion of March 6.” Further, the notification suggests changing the deadline data values 1330 to an updated deadline data value 1335.

The method 1200 may include an optional step, block 417, of receiving, by the computing platform, a confirmation to alter the at least one current data field, based on the current updated value. Further, the method 1200 includes updating the one or more current data fields of the current construction-based data object 1206B, based on the output of the machine learning model 1220, as illustrated in block 418. In the optional examples wherein block 417 is executed, the updating of block 418 may be performed in response to the confirmation to alter the deadline data field.

In the present example and with continued reference to FIG. 13B, a user of the end user device 300 may select, based on one or more new data values provided by output from the machine learning model 1220, whether to change the data values of the deadline field or not, via user input from a data input for selection associated with the notification 1340. For example, the notification 1340 includes an input of “YES” and “NO,” in response to a prompt for altering the deadline data values; if the user selects, via, for example, touch screen or peripheral input, “YES,” then the method 800 will proceed to block 418. Then, the data values for the deadline field 916 are updated to the new deadline data values 1335, as suggested by the machine-learning model 1220. Alternatively, if the user selects “NO,” then the deadline field 916 will not be altered.

FIG. 13C is an illustration of a third state of the visual interface 1300C, wherein the user has confirmed that he/she/they accepts the new data values 1335 for the deadline field 916. Accordingly, based on the suggestions and data provided by the machine learning model 1220, the method 1200 has automatically generated a new and potentially optimal deadline for response to the construction-based data object.

### iv. Utilizing Systems and Methods of Automatically Generating Text Content to Revise Text Entries

As illustrated in the above examples, with respect to FIGS. 7-13, construction-based data objects may include a plurality of text-based fields. In fact, each of the fields 910, 912, 914, 916, 918, as depicted above, includes or comprises a text field. As discussed above, various machine-learning models, such as those that leverage NLP for generating real, human-like language, can be utilized in generating or altering text for a construction-based data object. To that end, for content generation purposes, the machine-learning models discussed herein may generate, alter, edit, or otherwise enter text into text fields of construction-based data objects, based on a quality assessment of previous entries to text fields.

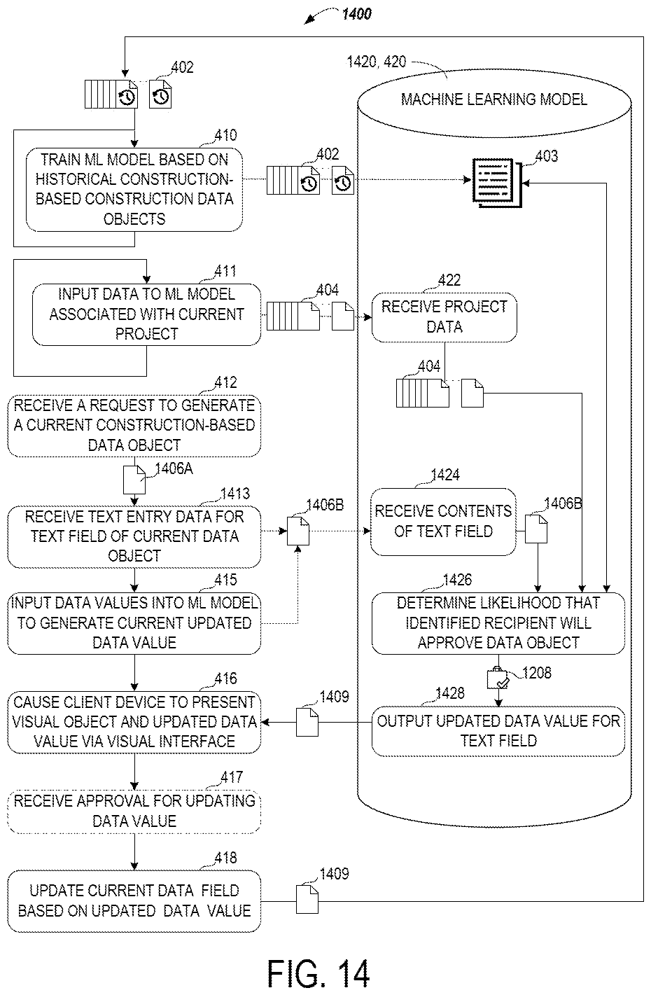

Regarding text fields associated with data objects, a machine-learning model 1420 associated with a method 1400 may be utilized to assess quality of an entry to a text field and use said assessment for altering the data entry to the text field, as illustrated in FIG. 14. For example, the machine-learning model 1420 may receive, as input, a text entry to a text field of an RFI data object, determine a quality assessment of the text in the text field and, based on the quality assessment, determine if the RFI will likely be approved by the manager of the RFI. In such examples, if the assessment by the machine-learning model indicates that the manager of the RFI most likely will not approve of the RFI, the machine-learning model may generate an altered or alternative text entry for the text field, because, based on the machine-learning model's assessment of quality, the altered or alternative text entry is more likely to be approved by the RFI manager.

To that end, FIG. 14 illustrates a flowchart for a method 1400 for automatically generating content for a construction-based data object. The method 1400 of FIG. 14 includes common and similar elements to those of the method 400 of FIG. 4. Common elements are labelled having the same reference numbers to those of FIG. 4, although the data, input, and/or output associated with the common elements, in FIG. 14, may be of a more specific form. Similar elements are labelled having the same two least significant digits as its similar element of the method 400 of FIG. 4 (e.g., block 1413 is similar to block 413).

The method 1400 includes block 410 and 411, wherein description of both is discussed, above, with respect to FIG. 4. Further still, the machine learning model 1420 may include similar elements to that of the machine learning model 420 and/or the machine learning model 420 may be capable of executing the functions, disclosed herein, of the machine learning model 1420.

The method 1400 may be useful for automatically generating content for data objects 1406 that include, at least, a text field for inputting a question to the construction-based data object, such as a question field. The method 1400 may be useful in improving questions input to a construction-based data object 1406, which require a response from a recipient of the construction-based data object 1406. In one example, the party that generates the construction-based data object 1406 may initially enter a text entry to a question field 912 of the construction-based data object 1406A. Then, via use of the machine-learning model(s) 1420, the systems and methods may determine a likelihood that a recipient will respond to the construction-based data object 1406B, based on an assessed quality of the text contents of the question field 912. Then, the systems and methods carried out by the computing platform 200 may alter and/or populate the question field 914 and/or provide a suggestion to allow the machine-learning model to alter the question field 912.

To that end, at block 412, the method 1400 includes receiving a request to generate a current construction-based data object 1406A associated with an ongoing construction project. In response to the request of block 412, the computing platform 200 may generate the current construction-based data object 1406A and/or populate one or more question-based text data fields of the current construction-based data object 1406A. In some examples, the current construction-based data object 1406A may be generated based on a request provided to the computing system 200 via, for example, a client station, such as an end-user device 300.

The method 1400 includes receiving one or more data values for one or more question data fields of the current construction-based data object 1406, as illustrated in block 1413. The question-based text data field may be any text field that contains, as data values, data indicative of a question for response of the construction-based data object.

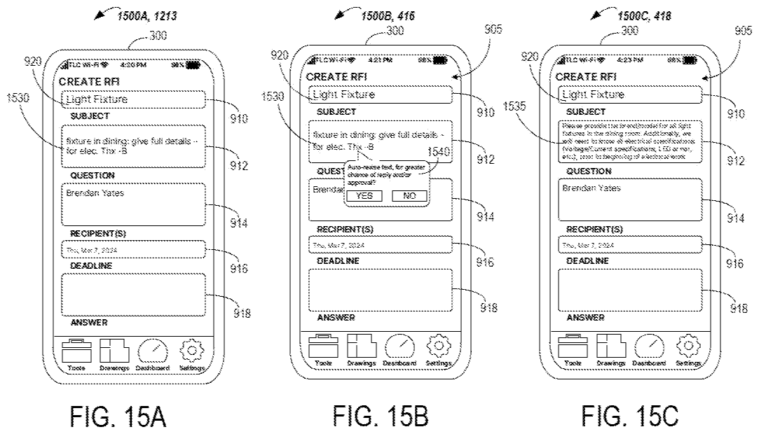

An example of a visual interface 1500 is illustrated in FIG. 15A-C, wherein the interface 1500 presents an RFI application, with which the method 1400 may be performed to provide updated data values for a question field or an associated data field indicative of information associated with a question of the construction-based data object. As illustrated, the visual interface 1500 includes the indication of a construction-based data object 905, represented as text data for an RFI. The indication of construction-based data object 905 comprises, for example, the subject field 910, the question field 912, the recipient field 914, the deadline field 916, and the answer field 918. While the examples of FIGS. 15A-C illustrate utilization of the method 1400 for automatically generating content for an RFI, the method 1400 certainly is not limited to use in generating content for RFIs and may be utilized in generating content for any construction-based data object.

FIG. 15A may be indicative of a first state of the visual interface 1500A, wherein a user may input text data values 1530 to the question field 912 and, accordingly, the first state of the visual interface 1500A may be a state of the interface 900 at block 1413 of the method 1400, wherein said input text data values 1530 are received by the computing system 200. As illustrated, the user of the end-user device 300 inputs the text data values 1530 into the indication of the construction-based data object 905.

The method 1400 further includes inputting one or more data values for the question data field of the current data object 1406 into the machine learning model 1420, as illustrated in block 415. To that end, the machine learning model 1420 is configured to receive, as input the one or more deadline data values for one or more deadline data fields of a construction-based data object, wherein the construction-based data object is associated with a construction project.

At block 1426, based on an evaluation of the received data values of the current construction-based data object 1406, in view of the training data set 403 and, optionally, the ongoing construction data 404, the machine learning model 1420 may be configured to determine a quality metric 1408 for the input data values to the machine learning model 1420. In one example of the method 1400, the quality metric 1408 is quality metric for the natural language or writing of the input text entry. To that end, in such examples, the machine-learning model 1420 is further configured to determine the quality of writing for the text entry by evaluating the text entry in view of a subset of the training data set, wherein the subset of the training data set includes a plurality of past construction-based data objects that were either completed or not completed within a given timeframe threshold. In other words, the quality metric 1408 may be utilized in comparing the text entry input to prior text entries of past completed construction projects, wherein the input text is evaluated against text entries that either did or did not lead to a timely response or completion.

Based on an evaluation of the input data, in view of one or more of the quality metric 1408, the training data 403, the ongoing construction project data 404, or combinations thereof, the machine learning model 1420 is further configured to output one or more of the updated current construction-based data object 1409, the updated data value(s) therein, or combinations thereof, as illustrated in block 1428. This output data may be data indicative of a likelihood that the intended recipient of the recipient field 914 responds to the construction-based data object 1406 by the input deadline, based on a perceived quality of the writing. The output data may further include a suggestion to alter the text of the question field 912.

After the method 1400, then, performs the functions of one or more of blocks 415, 1424, 1426, and 1428, the method 1400 proceeds to block 416, wherein the computing system 200 causes the client device 200 to present a visual representation of the data object (e.g., the indication of the construction based data object 905) and an updated data value via a second state of the visual interface 1400B, as illustrated in FIG. 14B. As illustrated, an updated data value may include a suggestion to automatically revise input text, suggested via a notification 1540, which may include data inputs for selection by the user. The updated data value, based on the output of the machine learning model 1420, may be, for example, an indication or notification that an intended recipient will not likely respond to the construction-based data object, by the deadline, due to poor quality of written contents of the question field 912.

In this example, the notification 1540 may include data that is derived from or otherwise indicative of or associated with the quality metric 1408. In the present example, the machine-learning model 1420 has determined, via evaluating the input data values of the construction-based data object 1406B, in view of, at least, the training data set 403, that output of automatic content generation, for revising the text data 1530, may result in a greater chance for response to the question. Further, the notification 1540 may suggest changing the text data values 1530 to an updated text data value 1535.

The method 1400 may include an optional step, block 417, of receiving, by the computing platform, a confirmation to alter the at least one current data field, based on the current updated value. Further, the method 1400 includes updating the one or more current data fields of the current construction-based data object 1406B, based on the output of the machine learning model 1420, as illustrated in block 418. In the optional examples wherein block 417 is executed, the updating of block 418 may be performed in response to the confirmation to alter the question data field.

In the present example and with continued reference to FIG. 15B, a user of the end user device 300 may select, based on one or more new data values provided by output form the machine learning model 1420, to automatically revise the text of the question field 912, via user input from a data input for selection associated with the notification 1540. For example, the notification 1540 includes an input of “YES” and “NO,” in response to a prompt for altering the data values held by the question field 912. If the user selects, via, for example, touch screen or peripheral input, “YES,” then the method 800 will proceed to block 418. Then, the data values for the question field 912 are updated to the new text data values 1535, as suggested by the machine-learning model 1420. Alternatively, if the user selects “NO,” then the data values of the question field 912 will not be altered.

FIG. 15C is an illustration of a third state of the visual interface 1500C, wherein the user has confirmed that he/she/they accepts the new text data values 1335 for the question field 912. Accordingly, based on the suggestions and data provided by the machine learning model 1420, the method 1400 has automatically generated a new and potentially optimal text entry, which may have a greater chance of garnering a response to the question of the construction-based data object.

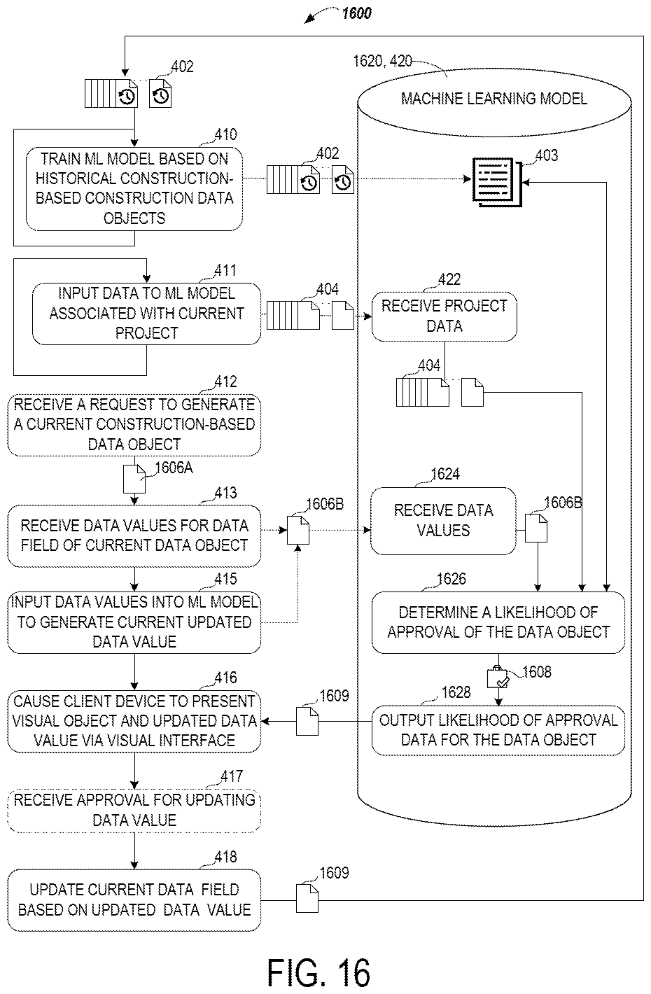

FIG. 16 is an illustration of a flowchart for another method 1600 for automatically generating content for a construction-based data object. The method 1600 of FIG. 16 includes common and similar elements to those of the method 400 of FIG. 4. Common elements are labelled having the same reference numbers to those of FIG. 4, although the data, input, and/or output associated with the common elements, in FIG. 16, may be of a more specific form. Similar elements are labelled having the same two least significant digits as its similar element of the method 400 of FIG. 4 (e.g., block 1613 is similar to block 413).

The method 1600 includes blocks 410 and 411, wherein description of both is discussed, above, with respect to FIG. 4. Further still, a machine learning model 1620 may include similar elements to that of the machine learning model 420 and/or the machine learning model 420 may be capable of executing the functions, disclosed herein, of the machine learning model 1620.

The method 1600 may be useful for automatically generating content for data objects 1606 that include, at least, a text field for an answer to a question to the construction-based data object. The method 1600 may be useful in optimizing answers input in response to a question of a construction-based data object 1606, which require approval from a manager of the construction-based data object 1606. In one example, the party that receives the construction-based data object 1606 may initially enter a text entry to an answer field 918 of the construction-based data object 1606A. Then, via use of the machine-learning model 1620, the systems and methods may determine a likelihood that an entered intended recipient will approve the construction-based data object 1606B, based on an assessed quality of the text contents of the answer field 918. Then, the systems and methods carried out by the computing platform 200 may alter and/or populate the answer field 918 and/or provide a suggestion to allow the machine-learning model to alter the answer field 918.

The method of 1600 of FIG. 16 relates to a user having received a construction-based data object and a subsequent evaluation and potential revision of an answer field input to the construction-based data object. While the user who may ultimately benefit from output of the method 1600 may not, themselves, generate the construction-based data object, at block 412, the method 1600 includes receiving a request to generate a current construction-based data object 1606A associated with an ongoing construction project. In response to the request of block 412, the computing platform 200 may generate the current construction-based data object 1606A. In some examples, the current construction based data object 1606A may be generated based on a request provided to the computing system 200 via, for example, a client station, such as an end-user device 300.

The method 1600 includes receiving one or more data values for one or more answer data fields of the current construction-based data object 1606, as illustrated in block 1613. The answer-based text data field may be any text field that contains, as data values, data indicative of an answer in response to a question for the construction-based data object.

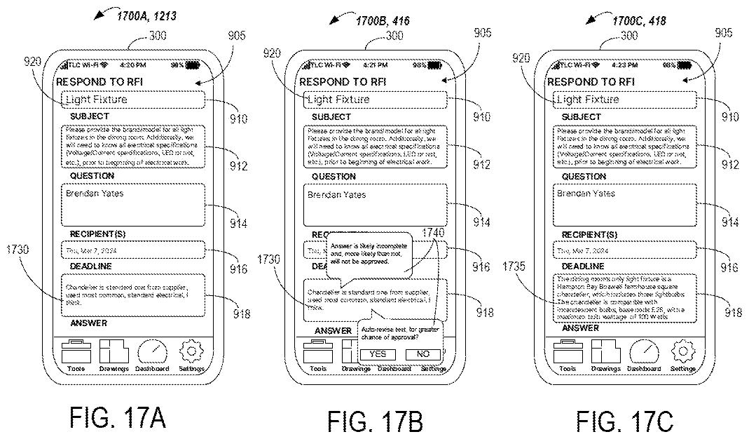

An example of a visual interface 1700 is illustrated in FIG. 17A-C, wherein the interface 1700 shows an RFI application, with which the method 1600 may be performed to provide updated data values for an answer field or an associated data field indicative of information associated with an answer to a question of the construction-based data object. As illustrated, the visual interface 1700 includes the indication of a construction-based data object 905, represented as text data for an RFI. The indication of construction-based data object 905 comprises, for example, the subject field 910, the question field 912, the recipient field 914, the deadline field 916, and the answer field 918. While the examples of FIGS. 17A-C illustrate utilization of the method 1600 for automatically generating content for an RFI, the method 1700 certainly is not limited to use in generating content for RFIs and may be utilized in generating content for any construction-based data object.

FIG. 17A may be indicative of a first state of the visual interface 1700A, wherein a user may input text data values 1730 to the answer field 918 and, accordingly, the first state of the visual interface 1700A may be a state of the interface 900 at block 1613 of the method 1600, wherein said input text data values 1730 are received by the computing system 200. As illustrated, the user of the end-user device 300 inputs the text data values 1730 into the indication of the construction-based data object 905.

The method 1600 further includes inputting one or more data values for the answer data field of the current data object 1606 into the machine learning model 1620, as illustrated in block 415. To that end, the machine learning model 1620 is configured to receive, as input the one or more deadline data values for one or more deadline data fields of a construction-based data object, wherein the construction-based data object is associated with a construction project.

At block 1626, based on an evaluation of the received data values of the current construction-based data object 1606, in view of the training data set 403 and, optionally, the ongoing construction data 404, the machine learning model 1620 may be configured to determine a quality metric 1608 for the input data values to the machine learning model 1620. In one example of the method 1600, the quality metric 1608 is a quality metric for the natural language or writing of the input text entry. To that end, in such examples, the machine-learning model 1620 is further configured to determine the quality of writing for the text entry by evaluating the text entry in view of a subset of the training data set, wherein the subset of the training data set includes a plurality of past construction-based data objects that were approved or denied by a managing party of the respective past data objects. In other words, the quality metric 1608 may be utilized in comparing the text entry input to prior text entries of past completed construction projects, wherein the input text is evaluated against text entries that led to a manager approval or denial of the text entries to the data objects.

In some additional or alternative examples, the quality metric may be a determination if the contents of the input to the answer field, and not just the text quality thereof, provides the necessary information for responding to the question of the construction based data object. In other words, the quality metric 1608, in some examples, may be a qualitative or subjective metric as to whether the input answer provides full contents and/or context, in its information, in response to the question input of the construction-based data object.

Based on an evaluation of the input data, in view of one or more of the quality metric 1608, the training data 403, the ongoing construction project data 404, or combinations thereof, the machine learning model 1620 is further configured to output one or more of the updated current construction-based data object 1609, the updated data value(s) therein, or combinations thereof, as illustrated in block 1628. This output data may be data indicative of a likelihood that the manager of the construction-based data object approves of the data values 1730 input to the answer field 918, based on a perceived quality of the writing or the contents thereof. The output data may further include a suggestion to alter the text of the answer field 918.

After the method 1600, then, performs the functions of one or more of blocks 415, 1624, 1626, and 1628, the method 1600 proceeds to block 416, wherein the computing system 200 causes the client device 200 to present a visual representation of the data object (e.g., the indication of the construction based data object 905) and an updated data value via a second state of the visual interface 1600B, as illustrated in FIG. 16B. As illustrated, an updated data value may include a suggestion to automatically revise input text, suggested via a notification 1740, which may include data inputs for selection by the user. The updated data value, based on the output of the machine learning model 1620, may be, for example, an indication or notification that a manager of the construction-based data object will not likely approve of the answer of the construction-based data object, due to poor quality of written contents of the answer field 918.

In this example, the notification 1740 may include data that is derived from or otherwise indicative of or associated with the quality metric 1608. In the present example, the machine-learning model 1620 has determined, via evaluating the input data values of the construction based data object 1606B, in view of, at least, the training data set 403, that automatic content generation for revising the text data 1730 may result in a greater chance for approval. Further, the notification 1740 may suggest changing the text data values 1730 to an updated text data value 1735.

The method 1600 may include an optional step, block 417, of receiving, by the computing platform, a confirmation to alter the at least one current data field, based on the current updated value. Further, the method 1600 includes updating the one or more current data fields of the current construction-based data object 1606B, based on the output of the machine learning model 1620, as illustrated in block 418. In the optional examples wherein block 417 is executed, the updating of block 418 may be performed in response to the confirmation to alter the answer data field.

In the present example and with continued reference to FIG. 17B, a user of the end user device 300 may select, based on one or more new data values provided by output form the machine learning model 1620, to automatically revise the text of the answer field 918, via user input from a data input for selection associated with the notification 1740. For example, the notification 1740 includes an input of “YES” and “NO,” in response to a prompt for altering the answer field 918 data values; if the user selects, via, for example, touch screen or peripheral input, “YES,” then the method 1600 will proceed to block 418. Then, the data values for the answer field 918 are updated to the new text data values 1735, as suggested by the machine-learning model 1620. Alternatively, if the user selects “NO,” then the data values of the answer field 918 will not be altered.

FIG. 17C is an illustration of a third state of the visual interface 1700C, wherein the user has confirmed that he/she/they accepts the new text data values 1735 for the answer field 918. Accordingly, based on the suggestions and data provided by the machine learning model 1620, the method 1600 has automatically generated new and potentially optimal text data, which may have a greater likelihood of garnering an approval for an answer to a question of a construction-based data object.

### v. Utilizing Systems and Methods of Automatically Generating Text Content for Answers to Submittal-Based Data Objects

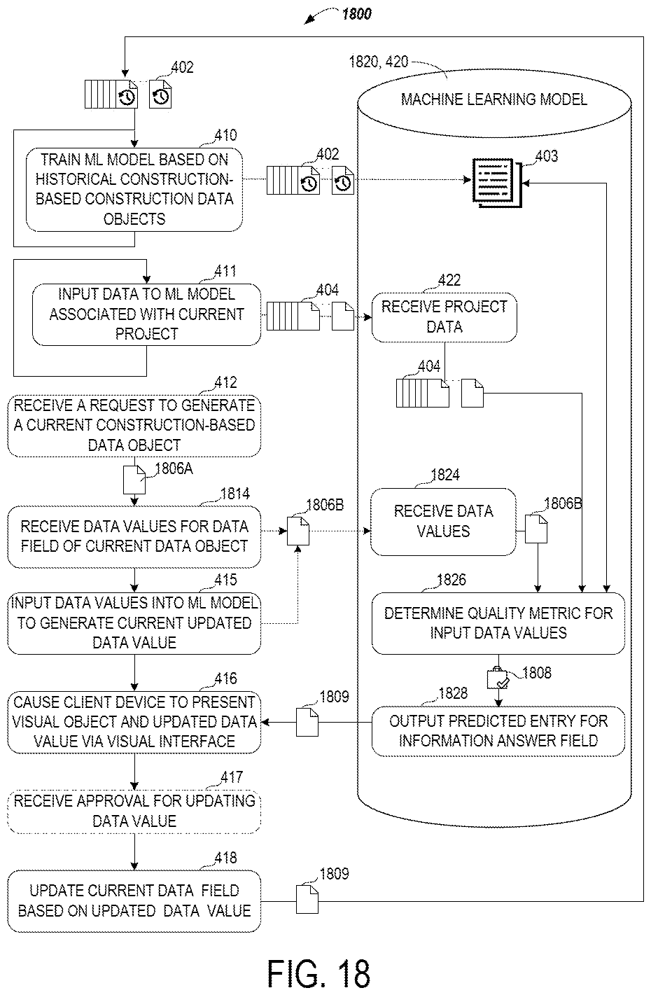

With enough training and knowledge of a current construction project, in some examples, such as the method 1800 of FIG. 18, the computing system 200 may utilize a machine-learning model 1820 to automatically generate data for an answer field for a submittal-based construction-based data object. For example, a user may generate an RFI data object and input text data into a question-based text field for the RFI data object.

FIG. 18 illustrates a flowchart for a method 1800 for automatically generating content for a construction-based data object. The method 1800 of FIG. 18 includes common and similar elements to those of the method 400 of FIG. 4. Common elements are labelled having the same reference numbers to those of FIG. 4, although the data, input, and/or output associated with the common elements, in FIG. 18, may be of a more specific form. Similar elements are labelled having the same two least significant digits as its similar element of the method 400 of FIG. 4 (e.g., block 1613 is similar to block 413).

The method 1800 includes blocks 410 and 411, wherein description of both is discussed, above, with respect to FIG. 4. Further still, a machine learning model 1820 may include similar elements to that of the machine learning model 420 and/or the machine learning model 420 may be capable of executing the functions, disclosed herein, of the machine learning model 1820.

The method 1800 may be useful for automatically generating content for data objects 1806 that include, at least, a text field for an answer to a question to the construction-based data object, such as an answer field. The method 1800 may be useful automatically generating answers in response to a question of a construction-based data object 1806. In one example, the user requesting generation of the construction-based data object 1806 may initially enter a text entry to a question field 912 of the construction-based data object 1806A. Then, via use of the machine-learning model(s) 1820, the systems and methods may automatically determine an entry to an answer field 918 of the construction based data object, based on an evaluation of the text entry to the question field, in view of training data and input data of the machine learning model 1820, which includes ongoing construction project data. Then, the systems and methods carried out by the computing platform 200 may populate the answer field 918 and/or provide a suggestion to allow the machine-learning model to alter the answer field 918.

To that end, at block 412, the method 1800 includes receiving a request to generate a current construction-based data object 1806A associated with an ongoing construction project. In response to the request of block 412, the computing platform 200 may generate the current construction-based data object 1806A and/or populate one or more question-based text data fields of the current construction-based data object 1806A. In some examples, the current construction-based data object 1806A may be generated based on a request provided to the computing system 200 via, for example, a client station, such as an end-user device 300.

The method 1800 includes receiving one or more data values for one or more question data fields of the current construction-based data object 1806, as illustrated in block 1813. The question-based text data field may be any text field that contains, as data values, data indicative of question intended for response, within a construction-based data object.

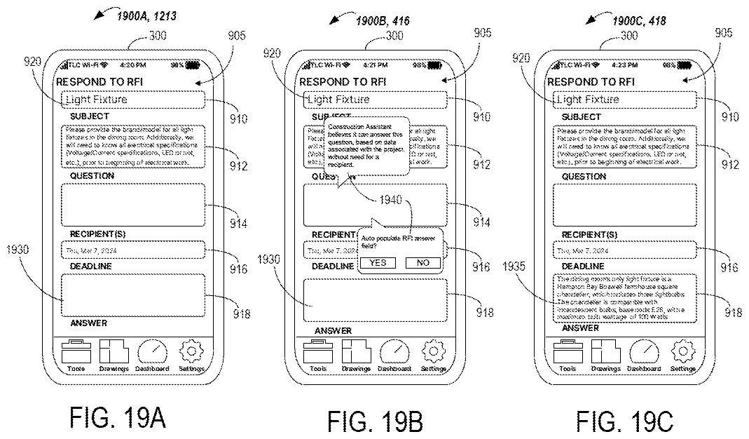

An example of a visual interface 1900 is illustrated in FIGS. 19A-C, wherein the interface 1900 shows an RFI application, wherein the method 1800 may be performed to provide automatically generated content for data values for an answer field. As illustrated, the visual interface 1900 includes the indication of a construction-based data object 905, represented as text data for an RFI. The indication of construction-based data object 905 comprises, for example, the subject field 910, the question field 912, the recipient field 914, the deadline field 916, and the answer field 918. While the examples of FIGS. 19A-C illustrate utilization of the method 1800 for automatically generating content for an RFI, the method 1800 certainly is not limited to use in generating content for RFIs and may be utilized in generating content for any construction-based data object.

FIG. 19A may be indicative of a first state of the visual interface 1900A, wherein a user may input text data values to a question field 1920 and, accordingly, the first state of the visual interface 1900A may be a state of the interface 1900A at block 1813 of the method 1800, wherein said answer text data values 1730 are populated by the computing system 200 as no value.

The method 1800 further includes inputting one or more data values for the question data field of the current data object 1606 into the machine learning model 1620, as illustrated in block 415, such as contents of the question field 912. To that end, the machine learning model 1820 is configured to receive, as input, contents of the question field 912.

At block 1826, based on an evaluation of the received data values of the current construction-based data object 1806, in view of the training data set 403 and/or the ongoing construction data 404, the machine learning model 1820 may be configured to determine a quality metric 1808 for the input data values to the machine learning model 1820. In one example of the method 1800, the quality metric 1808 is a confidence score that the machine learning model 1820 can predict an answer to the contents of the question field 912, based on an evaluation of the ongoing construction data 404, in view of the training data set 403.

Based on an evaluation of the input data, in view of one or more of the quality metric 1808, the training data 403, the ongoing construction project data 404, or combinations thereof, the machine learning model 1820 is further configured to output one or more of the updated current construction-based data object 1809, the updated data value(s) therein, or combinations thereof, as illustrated in block 1828. This output data may be an automatic response to the contents of the question field 912, as input to the answer field 918, absent input from a responding party to the construction-based data object.

After the method 1800, then, performs the functions of one or more of blocks 415, 1824, 1826, and 1828, the method 1800 proceeds to block 416, wherein the computing system 200 causes the client device 200 to present a visual representation of the data object (e.g., the indication of the construction based data object 905) and an updated data value via a second state of the visual interface 1800B, as illustrated in FIG. 18B. As illustrated, an updated data value may include a suggestion to automatically generate response text, suggested via a notification 1840, which may include data inputs for selection by the user. The updated data value, based on the output of the machine learning model 1820, may be, for example, an indication that the computing system 200 has enough knowledge of the current construction project to automatically generate a text answer to the contents of the question field 912.

In this example, the notification 1940 may include data that is derived from or otherwise indicative of or associated with the quality metric 1808. In the present example, the machine-learning model 1820 has determined, via evaluating the input data values of the construction-based data object 1806B, in view of, at least, the training data set 403, that automatic content generation for the answer field 918 is available and said contents will be accurate. Further, the notification 1940 may suggest changing the text data values 1930 (null) to an updated text data value 1935 (generated content).

The method 1800 may include an optional step, block 417, of receiving, by the computing platform, a confirmation to alter the at least one current data field, based on the current updated value. Further, the method 1800 includes updating the one or more current data fields of the current construction-based data object 1806B, based on the output of the machine learning model 1820, as illustrated in block 418. In the optional examples wherein block 417 is executed, the updating of block 418 may be performed in response to the confirmation to alter the answer data field.

In the present example and with continued reference to FIG. 19B, a user of the end user device 300 may select, based on one or more new data values provided by output form the machine learning model 1820, to automatically generate the text of the answer field 918, via user input from a data input for selection associated with the notification 1940. For example, the notification 1940 includes an input of “YES” and “NO,” in response to a prompt for altering the data values for the answer field 918; if the user selects, via, for example, touch screen or peripheral input, “YES,” then the method 1800 will proceed to block 418. Then, the data values 1930 (null) for the answer field 918 are updated to the new text data values 1935, as suggested by the machine-learning model 1820. Alternatively, if the user selects “NO,” then the data values of the answer field 918 will not be populated.

FIG. 19C is an illustration of a third state of the visual interface 1900C, wherein the user has confirmed that he/she/they accepts the new text data values 1935 for the answer field 918. Accordingly, based on the suggestions and data provided by the machine learning model 1820, the method 1800 has automatically generated new text data for an answer to a question of a construction-based data object.

As discussed, the method 1900 may be utilized to eliminate the need for sending a construction-based data object amongst multiple parties; instead, the automatically generated answer for the user reduces the need for another party to be involved in information gathering. However, the method 1900 may similarly be utilized to generate said answer, which then may be provided to another party to the construction project. Consider a user generates an RFI and the method 1900 is utilized to automatically generate an answer to the user's question of the RFI. However, the user may require verification of the automatically generated answer to the RFI and, thus, still submit the RFI to another user who would be qualified to answer the RFI, with or without the automatically generated answer. Now, the user can get his/her/their question answered, in the RFI, and the verifying party has had his/her/their workload or effort load reduced, as he/she/they may only have to review and approve/deny/edit the answer to the RFI, rather than spending the time to fully input an answer.

### vi. Leveraging Trained Machine-Learning Models to Automatically Generate Entire Construction-Based Data Objects

Some of the aforementioned examples of leveraging the disclosed technology for automatically generating content for construction-based data objects require at least some nominal data input to data fields of a data object, prior to content generation for the data object. However, in some other examples, the machine-learning models disclosed herein may be utilized to automatically generate construction-based data objects based on one or more of contextual input to the computing platform, general observations of actions of a user made by the machine-learning model or an input to the model, or combinations thereof.

For example, a method 2000 for automatically generating a construction-based data object is illustrated in FIG. 20. In some such examples, the method 200 may be carried out by the computing platform, utilizing a machine learning model 2020. The machine learning model 2020 may include similar elements to that of the machine learning model 420 and/or the machine learning model 420 may be capable of executing the functions, disclosed herein, of the machine learning model 2020.

At optional block 2005, it is indicated that one or both of the computing system 200 and/or the machine learning model may receive input data, as outcome data or resultant data of one or more instances of executing the method 400, wherein the input data is then used as training data for the machine-learning model 2020, to further retrain the machine-learning model 2020 on past automatically generated content for construction-based data objects, as illustrated in block 2010. Thus, an updated or retrained training data set 2003 is generated for the machine-learning model 2020.

Returning now to FIG. 6, and with continued reference to FIG. 20, the machine-learning model 420 and/or the machine-learning model 2020 may include the action prediction model 610. The action prediction model 610 may be utilized, by the computing system 200 and/or the machine learning models 420, 2020 thereof, to observe and/or monitor user input 2002 to the computing system 200 and output some instructions for automatically generating content for an existing construction-based data object and/or an entirely new construction-based data object. In this regard, the user input 2002 any input to a computing system, from a user, that may not be specifically directed to a previously existing data object known to the inputting user and/or any input to a computing system, from a user, that is not specific input to a data object. Examples of the user input 2002 may include, but are not limited to including, entries to a search engine or search function of a platform, observed actions of a user indicating a desire for information, input to a prompt to a user asking if he/she/they desire some specific information, among other things.

For example, a user of the computing platform 200, via an end-user device 300, may ask a broad search query, either via a search function for data on the computing platform 200 or another application for finding information. The computing platform 200 and/or the associated machine-learning model(s) 420, 2020 may attempt to provide the user with a correct answer to this query. However, if that information is not confidently held in or supported by data of the computing platform 200 and/or machine-learning model(s) 420, 2020, then the machine-learning model(s) 420, 2020 may automatically generate instructions to generate a construction-based data object, for the purposes of answering the user's search query (e.g., the action prediction model 610 monitors broad user input 2007, to generate object generation instructions 410, ingested by the content generation model 630, to generate a construction-based data object).

For example, the machine-learning model(s) 420, 2020 may provide output that is leveraged by the computing system to automatically generate an RFI requesting an answer for the query. Additionally or alternatively, the machine-learning model(s) 420, 2020 and/or an input process thereof may monitor activity of a user on the platform, as user input 2002 and, based on the context of the user's actions (e.g., what file folders the user is opening, what documents the user is viewing currently, etc.) predict that the user is searching for some specific set of information. In said examples, rather than reacting to a search query, the machine-learning model(s) 420, 2020 may generate a suggestion to generate a construction-based data object, based on observations of the user's actions, and, in response to affirmative input to the suggestion to generate the construction-based data object, provide output to the computing system for generating the predicted construction-based data object.

Returning to FIG. 20, the method further includes block 2012, wherein, based on receipt and/or monitoring of user input 2002, the computing system 200 determines and/or receives a request to generate a new construction-based data object. In some examples, the method 2000 includes block 2032, wherein the machine-learning model 2020 determines and/or otherwise generates a request to generate a construction-based data object, based on the user input 2002 input to the machine learning model 2020. The request to generate the new construction-based data object is then input to the machine-learning model 2020, as illustrated in block 2014, and the request to generate the new data object 2034 is received by the machine learning model 2020.

Based on an evaluation of the received request to generate the new construction-based data object in view of one or more of the training data set(s) 403, 2003, the method 2000 further includes determining and outputting instructions and/or data for generating the new construction-based data object, by the machine-learning model 2020, as illustrated in block 2036. The computing platform 200 then may generate the new construction-based data object based on the output of the machine-learning model 2020 and, optionally, display the generated new construction-based data object, to a user of an end-user device 300, via a visual interface, as illustrated in block 2016.

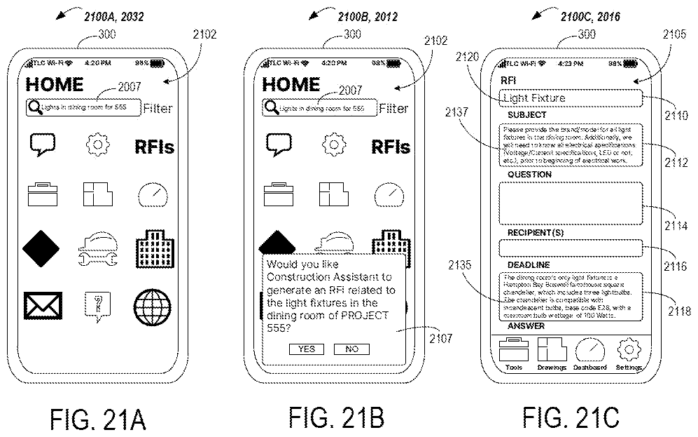

Examples of said visual interface(s) 2100 are illustrated in FIGS. 21A-C. In FIG. 21A, the machine-learning model 2020 is monitoring the user input 2002 of a user to a home screen interface 2102 of an application displayed by the end-user device 300. Based on ingestion of the user input 2002 (in this example, an input to a search function of the home screen interface 2102), the machine-learning model 2020 may provide output for generating a new construction-based data object, which may be a function of block 2032 of the method 2000.

Turning now to FIG. 21B, a second instance of the interface 2100B includes a prompt 2107 that may be generated, based on output of the machine-learning model 2020, as an indication, to the user, that the computing system 200 recognizes that the user is searching for some specific information and the computing platform 200 and/or machine-learning model thereof can generate the new construction-based data object to answer the user's query. In the given example, the prompt 2107 asks the user if he/she/they wish to have the computing platform 200 automatically generate an RFI related to the search query. If the user selects the “YES” input, via a touch screen and/or peripheral input, then the computing platform may proceed to generate a new construction-based data object.

Then, as illustrated in FIG. 21C, a third state of the interface 2100C is triggered, which shows an indication 2105 of the new construction-based data object (e.g. an RFI for answering the user's search query), as automatically generated via the method 2000 executed by the computing platform 200. In the example indication 2105, the new construction-based data object includes a subject field 2110 with automatically generated subject content 2120, a question field 2112 with automatically generated question content 2137, a recipient field 2114, a deadline field 2116, and an answer field 2118 with automatically generated answer content 2135. In the example of FIG. 21C, the computing platform 200 and/or the machine-learning model 2020 may have had enough knowledge of the construction project that the machine-learning model 2020 was capable of automatically generating an answer to the automatically generated question content 2137, similar to the method 1800 of FIGS. 18-19C. Alternatively, if the computing platform 200 and/or the machine-learning model 2020 thereof is not confident that it can accurately provide the automatically generated answer content 2135, then the method 200 may automatically generate content for one or more of the recipient field 2114, the deadline field 2116, or combinations thereof, but not the answer field 2118. Then, the user will interact with the new construction-based data object (e.g., submit to recipient, approve answer, etc.), in a similar way as he/she/they would interact with a construction-based data object, that was generated via direct user input.

### IV. CONCLUSION

Example embodiments of the disclosed innovations have been described above. Those skilled in the art will understand, however, that changes and modifications may be made to the embodiments described without departing from the true scope and spirit of the present invention, which will be defined by the claims.

While the foregoing is described in the context of data objects related to construction projects, it should be understood that the disclosed technology may be utilized in connection with other kinds of data objects as well. For example, the disclosed technology may be utilized for automatically generating content for data objects associated with professional or business tasks and projects, data objects associated with academic tasks and projects, data objects associated with legal tasks and projects, data objects associated with interpersonal or social tasks or projects, and the like.

For instance, those in the art will understand that the disclosed operations for training and utilizing machine-learning models and/or LLMs in the manner described herein to generate data for data objects and/or perform actions based on said generated data, may not be limited to only construction projects. Rather, the disclosed operations could be used in other contexts in connection with other types of projects as well.

Further, to the extent that examples described herein involve operations performed or initiated by actors, such as “humans,” “operators,” “users,” or other entities, this is for purposes of example and explanation only. The claims should not be construed as requiring action by such actors unless explicitly recited in the claim language.

1. A computing platform comprising:
at least one network interface;
at least one processor;
at least one non-transitory computer-readable medium; and
program instructions stored on the at least one non-transitory computer-readable medium that are executable by the at least one processor such that the computing platform is configured to:
train a machine-learning model by carrying out a first machine learning process on a training data set that includes a plurality of historical construction-based data objects, each of the plurality of historical construction-based data objects including (i) one or more data fields comprising respective historical data values and (ii) a respective indication of a resolution of the historical construction-based data object, wherein the machine-learning model is configured to (i) receive, as input, one or more input data values for one or more data fields of a construction-based data object, the construction-based data object associated with a construction project, (ii) output an updated data value for at least one of the one or more data fields of the construction-based data object,
receive a request to generate a current construction-based data object associated with an ongoing construction project,
receive one or more data values for one or more current data fields of the current construction-based data object,
input one or more data values for the one or more current data fields of the current construction-based data object into the machine-learning model, as the input data value, and thereby generate a current updated data value for at least one of the one or more current data fields,
cause a client device to present a visual interface, the visual interface usable for viewing an indication of the current construction-based data object and an indication of the current updated data value, and
update the one or more current data fields of the current construction-based data object, based on the current updated data value.

2. The computing platform of claim 1, wherein the machine-learning model is further configured to, based on an evaluation of the input data values for the one or more data fields, in view of the training data set, determine a quality metric for the input data values for the one or more data fields, and
wherein the program instructions that are executable by the at least one processor such that the computing platform is configured to output the updated data value for the at least one of the one or more data fields, by the machine-learning model, is based on the quality metric.

3. The computing platform of claim 2, wherein the one or more current data fields includes a recipient field, the recipient field indicative of a recipient of the current construction-based data object,
wherein the data value for the one or more current data fields includes a plurality of identified recipients for the recipient field, and
wherein the quality metric is a likelihood that each of the plurality of recipients for the recipient field will respond to the construction-based data object,
wherein the machine-learning model is configured to determine a member of the plurality of recipients that is most likely to respond to the construction-based data object based on the quality metric, and
wherein the updated data value is the member of the plurality of recipients that is most likely to respond to the construction-based data object.

4. The computing platform of claim 2, wherein the one or more current data fields includes a deadline field, the deadline field indicative of a deadline for at least one task of the current construction project,
wherein the quality metric is a projected timeframe for completing the at least one task of the current construction project, and
wherein the updating of the one or more current data fields of the current construction-based data object includes populating the deadline field based on the current updated value.

5. The computing platform of claim 2, wherein the one or more current data fields includes at least one text field,
wherein the data values for the one or more current data fields includes a text entry to one of the at least one text field,
wherein the current updated value is a revised text entry to the one of the at least one text field, and
wherein the updating of the one or more current data fields of the current construction-based data object includes populating the one of the at least one text field based on the current updated value.

6. The computing platform of claim 5, wherein the quality metric is a determinative quality of writing for the text entry, and
wherein the machine-learning model is further configured to determine the determinative quality of writing for the text entry by evaluating the text entry in view of a subset of the training data set, the subset of the training data set including a plurality of past construction-based data objects that were completed within a given timeframe threshold.

7. The computing platform of claim 2, further comprising program instructions stored on the at least one non-transitory computer-readable medium that are executable by the at least one processor such that the computing platform is configured to:
generate an approval likelihood field for the one or more current data fields,
wherein the current updated value is an entry for the approval likelihood field,
wherein the updating of the one or more current data fields of the current construction-based data object includes populating the approval likelihood field based on the current updated value.

8. The computing platform of claim 1, further comprising program instructions stored on the at least one non-transitory computer-readable medium that are executable by the at least one processor such that the computing platform is configured to:
receive, from a user, a confirmation to alter the at least one of the one or more data fields, based on the current updated value, and
wherein updating the one or more current data fields of the current construction-based data object is performed in response to the confirmation.

9. The computing platform of claim 1, wherein the current construction-based data object is a current request for information (RFI) and the plurality of historical construction-based data objects includes a plurality of past RFIs.

10. The computing platform of claim 9, wherein the one or more current data fields includes an information request field and an information answer field,
wherein current updated value is a predicted entry for the information answer field, and
wherein the updating the one or more current data fields of the current construction-based data object includes populating the information answer field based on the predicted entry.

11. The computing platform of claim 1, wherein the one or more current data fields includes a recipient field, indicative of a recipient of the current construction-based data object,
wherein the current updated value is an updated value for the recipient field, and
wherein the updating the one or more current data fields of the current construction-based data object includes populating the recipient field based on the updated value for the recipient field.

12. The computing platform of claim 11, wherein the machine-learning model is further configured to, based on an evaluation of the input data values for the one or more data fields, in view of the training data set, determine a quality metric for the input data values for the one or more data fields, and
wherein outputting the updated data value for the at least one of the one or more data fields, by the machine-learning model, is based on the quality metric, and
wherein the quality metric is a predicted probability that one or more potential recipients will respond to receipt of the current construction-based data object.

13. The computing platform of claim 1, further comprising program instructions stored on the at least one non-transitory computer-readable medium that are executable by the at least one processor such that the computing platform is configured to:
retrain the machine-learning model by carrying out a second machine-learning process on a retraining data set that includes the first training data set and one or more of the current construction-based data object, the data values for one or more current data fields of the current construction-based data object, the current updated data value, or combinations thereof, wherein the machine-learning model is further configured to (i) receive, as input, a request for a new construction-based data object associated with the construction project, and (ii) output the new construction-based data object; and
receive a request to generate a new current construction-based data object associated with the ongoing construction project; and
input the request for the new current construction-based data object into the machine-learning model, as the request for the current construction-based data object, and thereby generating the new current construction-based data object,
wherein the visual interface is further usable for viewing the new construction-based data object.

14. The computing platform of claim 1, wherein the machine-learning model comprises a large language model (LLM).

15. At least one non-transitory computer-readable medium, wherein the at least one non-transitory computer-readable medium is provisioned with program instructions that, when executed by at least one processor, cause a computing platform to:
train a machine-learning model by carrying out a first machine learning process on a training data set that includes a plurality of historical construction-based data objects, each of the plurality of historical construction-based data objects including (i) one or more data fields comprising respective historical data values and (ii) a respective indication of a resolution of the historical construction-based data object, wherein the machine-learning model is configured to (i) receive, as input, one or more input data values for one or more data fields of a construction-based data object, the construction-based data object associated with a construction project, (ii) output an output updated data value for at least one of the one or more data fields of the construction-based data object;
receive a request to generate a current construction-based data object associated with an ongoing construction project;
receive one or more data values for one or more current data fields of the current construction-based data object;
input one or more data values for the one or more current data fields of the current construction-based data object into the machine-learning model, as the input data value, and thereby generate a current updated data value for at least one of the one or more current data fields;
cause a client device to present a visual interface, the visual interface usable for viewing an indication of the current construction-based data object and an indication of the current updated data value; and
update the one or more current data fields of the current construction-based data object, based on the current updated data value.

16. The at least one non-transitory machine readable medium of claim 15, wherein the machine-learning model is further configured to, based on an evaluation of the input data values for the one or more data fields, in view of the training data set, determine a quality metric for the input data values for the one or more data fields, and
wherein outputting the updated data value for the at least one of the one or more data fields, by the machine-learning model, is based on the quality metric.

17. The at least one non-transitory machine readable medium of claim 15, wherein the at least one non-transitory computer-readable medium is also provisioned with program instructions that, when executed by at least one processor, cause the computing platform to:
receive, from a user, a confirmation to alter the at least one of the one or more data fields, based on the current updated value, and
wherein updating the one or more current data fields of the current construction-based data object is performed in response to the confirmation.

18. A method carried out by a computing platform, the method comprising:
training a machine-learning model by carrying out a first machine learning process on a training data set that includes a plurality of historical construction-based data objects, each of the plurality of historical construction-based data objects including (i) one or more data fields comprising respective historical data values and (ii) a respective indication of a resolution of the historical construction-based data object, wherein the machine-learning model is configured to (i) receive, as input, one or more input data values for one or more data fields of a construction-based data object, the construction-based data object associated with a construction project, (ii) output an output updated data value for at least one of the one or more data fields of the construction-based data object;
receiving a request to generate a current construction-based data object associated with an ongoing construction project;
receiving one or more data values for one or more current data fields of the current construction-based data object;
inputting one or more data values for the one or more current data fields of the current construction-based data object into the machine-learning model, as the input data value, and thereby generating a current updated data value for at least one of the one or more current data fields;
causing a client device to present a visual interface, the visual interface usable for viewing an indication of the current construction-based data object and an indication of the current updated data value; and
updating the one or more current data fields of the current construction-based data object, based on the current updated data value.

19. The method of claim 18, wherein the machine-learning model is further configured to, based on an evaluation of the input data values for the one or more data fields, in view of the training data set, determine a quality metric for the input data values for the one or more data fields, and
wherein outputting the updated data value for the at least one of the one or more data fields, by the machine-learning model, is based on the quality metric.

20. The method of claim 18, further comprising generating an approval likelihood field for the one or more current data fields,
wherein the current updated value is an entry for the approval likelihood field,
wherein the updating of the one or more current data fields of the current construction-based data object includes populating the approval likelihood field based on the current updated value.
